(19) United States
(12) Patent Application Publication
(10) Pub. No.: US 2001/0009939 A1
(43) Pub. Date: Jul. 26, 2001

(54) STABILIZERS FOR POWDER COATINGS

(76) Inventors: HUGH STEPHEN LAVER, REINACH (CH); PETER NESVADBA, MARLY (CH)

Correspondence Address: JOANN L VILLAMIZAR, PATENT DEPARTMENT, CIBA SPECIALTY CHEMICALS CORPORATION, 540 WHITE PLAINS ROAD, TARRYTOWN, NY, 10591

(21) Appl. No.: 09/017,082

(22) Filed: Feb. 2, 1998

(30) Foreign Application Priority Data
Feb. 5, 1997 (CH) 251/97

(51) Int. Cl. C08K 5/34; C08K 5/15

(52) U.S. Cl. 524/91; 524/111

(57) ABSTRACT

A description is given of powder coating compositions comprising a) an organic film-forming binder and b) as stabilizer at least one compound of the benzofuran-2-one type. Powder coating compositions stabilized in this way reduce the discoloration of coatings during thermal curing, especially gas oven curing.

The present invention relates to powder coating compositions comprising an organic film-forming binder and as stabilizer at least one compound of the benzofuran-2-one type, and to the use thereof for reducing the discoloration of heat-curable powder coatings.

Powder coating is a known technology and is described, for example, in “Ullmann's Encyclopedia of Industrial Chemistry, Fifth, Completely Revised Edition, Volume A 18”, pages 438 to 444 (1991). In the powder coating process, a powder is generally fluidized by supplying air, electrostatically charged and applied to an earthed, preferably metallic substrate. The substrate is subsequently heated, in the course of which the adhering powder melts, coalesces and forms a coherent film on the metal surface. Since powder coating operates preferentially without solvent, this technology is especially friendly to the environment.

The curing of the powder coating compositions at elevated temperature, especially in a gas oven, is not without its difficulties. The nitrogen oxide gases present in the gas oven often cause unwanted discoloration of the coating.

In the prior art, powder coating compositions are stabilized with a mixture of a sterically hindered phenol, for example the octadecyl ester of 3-(3,5-di-tert-butyl-4-hydroxyphenyl)propionic acid, and an organic phosphite, for example tris(2,4-di-tert-butyl-phenyl) phosphite. With this stabilization, however, when the powder coating composition is cured at elevated temperature, especially in a gas oven, severe unwanted discoloration of the coating is observed. This discoloration can be suppressed somewhat if the sterically hindered phenol is abandoned and if stabilization is effected only with an organic phosphite. Stabilization of the powder coating with only an organic phosphite, however, has the disadvantage that the stability of the coating to oxidative attack is greatly reduced.

It is also desirable to stabilize powder coatings against overbaking. Such overbaking can occur, for example, if the conveyor belt remains at a standstill in the heated oven or if components require recoating because of coating defects.

The known stabilizers do not in every respect satisfy the stringent requirements that a stabilizer or a mixture of stabilizers should comply with, especially in relation to the discoloration of heat-curable powder coating compositions, especially those curable in gas ovens.

The use of compounds of the benzofuran-2-one type as stabilizers for organic polymers is known, for example, from U.S. Pat. No. 4,325,863; U.S. Pat. No. 4,388,244; U.S. Pat. No. 5,175,312; U.S. Pat. No. 5,252,643; U.S. Pat. No. 5,216,052; U.S. Pat. No. 5,369,159; U.S. Pat. No. 5,488,117; U.S. Pat. No. 5,356,966; U.S. Pat. No. 5,367,008; U.S. Pat. No. 5,428,162; U.S. Pat. No. 5,428,177 or U.S. Pat. No. 5,516,920.

It has now been found that compounds of the benzofuran-2-one type are particularly suitable as stabilizers for reducing the discoloration of powder coating compositions which can be cured by heat, especially in gas ovens.

The present invention therefore provides powder coating compositions comprising

a) an organic film-forming binder and

b) as stabilizer at least one compound of the benzofuran-2-one type.

Interest attaches to those powder coating compositions in which component (b) is a compound of the formula I

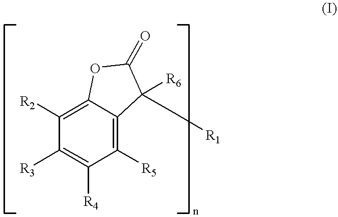

in which, if n is 1,

R₁, is unsubstituted or C₁-C₄alkyl-, C₁-C₄alkoxy-, C₁-C₄alkylthio-, hydroxyl-, halogen-, amino-, C₁-C₄alkylamino-, phenylamino- or di(C₁-C₄alkyl)amino-substituted naphthyl, phenanthryl, anthryl, 5,6,7,8-tetrahydro-2-naphthyl, 5,6,7,8-tetrahydro-1-naphthyl, thienyl, benzo[b]thienyl, naphtho[2,3-b]jthienyl, thianthrenyl, dibenzofuryl, chromenyl, xanthenyl, phenoxathiinyl, pyrrolyl, imidazolyl, pyrazolyl, pyrazinyl, pyrimidinyl, pyridazinyl, indolizinyl, isoindolyl, indolyl, indazolyl, purinyl, quinolizinyl, isoquinolyl, quinolyl, phthalazinyl, naphthyridinyl, quinoxalinyl, quinazolinyl, cinnolinyl, pteridinyl, carbazolyl, β-carbolinyl, phenanthridinyl, acridinyl, perimidinyl, phenanthrolinyl, phenazinyl, isothiazolyl, phenothiazinyl, isoxazolyl, furazanyl, biphenyl, terphenyl, fluorenyl or phenoxazinyl, or R₁ is a radical of the formula 11

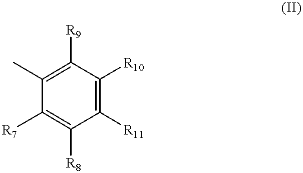

and,

if n is 2,

R₁ is unsubstituted or C₁-C₄alkyl- or hydroxyl-substituted phenylene or naphthylene; or is —R₁₂—X—R_{13—,}

R₂, R₃, R₄ and R₅ independently of one another are hydrogen, chlorine, hydroxyl, C₁—C₂₅—alkyl, C₇—C₉phenylalkyl, unsubstituted or C₁—C₄alkyl-substituted phenyl; unsubstituted or C₁—C₄alkyl-substituted C₅—C₈cycloalkyl; C₁—C₁₈alkoxy, C₁—C₁₈alkylthio, C₁—C₄alkylamino, di(C₁—C₄—alkyl)amino, C₁—C₂₅alkanoyloxy, C₁—C₂₅alkanoylamino, C₃—C₂₅alkenoyloxy, C₃—C₂₅—alkanoyloxy interrupted by oxygen, sulfur or

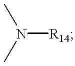

C₆—C₉cycloalkylcarbonyloxy, benzoyloxy or C₁—C₁₂alkyl-substituted benzoyloxy; or else the radicals R₂ and R₃ or the radicals R₃ and R₄ or the radicals R₄ and R₅, together with the carbon atoms to which they are attached, form a benzo ring, R₄ is additionally —(CH₂)_{P}—COR₁₅ or —(CH₂)_{q}OH or, if R₃, R₅ and R₆ are hydrogen, R₄ is additionally a radical of the formula III

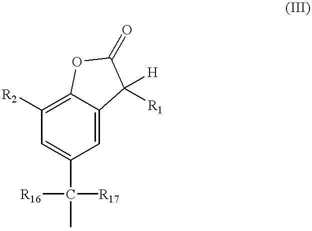

in which R₁ is as defined above for n=1, R6 is hydrogen or a radical of the formula IV

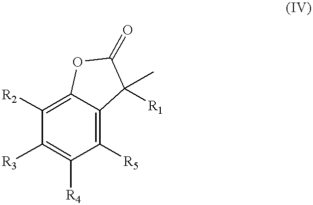

where R₄ is not a radical of the formula III and R₁ is as defined above for n=1, R₇, R₈, R₉, R₁₀ and R₁₁ independently of one another are hydrogen, halogen, hydroxyl, C₁—C₂₅alkyl, C₂—C₂₅alkyl interrupted by oxygen, sulfur or

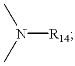

C₁—C₂₅alkoxy, C₂—C₂₅—alkoxy interrupted by oxygen, sulfur or

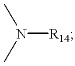

C₁—C₂₅alkylthio, C₃—C₂₅alkenyl, C₃—C₂₅—alkenyloxy, C₃—C₂₅alkynyl, C₃—C₂₅alkynyloxy, C7—Cgphenylalkyl, C₇—C₉phenylalkoxy, unsubstituted or C₁—C₄alkyl-substituted phenyl; unsubstituted or C₁—C₄alkyl-substituted phenoxy; unsubstituted or C₁—C₄alkyl-substituted C₅—C₈cycloalkyl; unsubstituted or C₁—C₄—alkyl-substituted C₅—C₈cycloalkoxy; C₁—C₄alkylamino, di(C₁—C₄alkyl)amino, C₁—C₂₅alkanoyl, C₃—C₂₅alkanoyl interrupted by oxygen, sulfur or

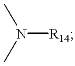

C₁—C₂₅alkanoyloxy, C₃—C₂₅—alkanoyloxy interrupted by oxygen, sulfur or

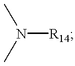

C₁—C₂₅alkanoylamino, C₃—C₂₅—alkenoyl, C₃—C₂₅alkenoyl interrupted by oxygen, sulfur or

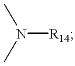

C₃—C₂₅alkenoyloxy, C₃—C₂₅alkenoyloxy interrupted by oxygen, sulfur or

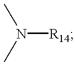

C₆—Cgcycloalkylcarbonyl, C₆—C₉cycloalkylcarbonyloxy, benzoyl or C₁—C₁₂alkyl-substituted benzoyl; benzoyloxy or C₁—C₁₂alkyl-substituted benzoyloxy;

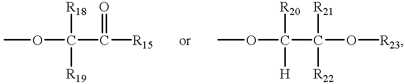

or else, in formula II, the radicals R₇ and R₈ or the radicals R₈ and R₁₁ , together with the carbon atoms to which they are attached, form a benzo ring, R₁₂ and R₁₃ independently of one another are unsubstituted or C₁—C₄alkyl-substituted phenylene or naphthylene, R₁₄ is hydrogen or C₁—C₈alkyl, R₁₅ is hydroxyl,

$$[ {—O}^{-} \frac{1}{r} {M}^{r +} ] ,$$

C₁—C₁₈alkoxy or

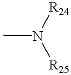

R₁₆ and R₁₇ independently of one another are hydrogen, CF₃, C₁—C₁₂alkyl or phenyl, or R₁₆ and R₁₇, together with the C atom to which they are attached, form an unsubstituted or mono- to tri—C₁—C₄alkyl-substituted C₅—C₈cycloalkylidene ring; R₁₈ and R₁₉ independently of one another are hydrogen, C₁—C₄alkyl or phenyl, R₂₀ is hydrogen or C₁—C₄alkyl, R21 is hydrogen, unsubstituted or C₁—C₄alkyl-substituted phenyl; C₁—C₂₅alkyl, C₂—C₂₅alkyl interrupted by oxygen, sulfur or

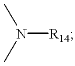

C₇—C₉phenylalkyl which is unsubstituted or substituted on the phenyl radical 1 to 3 times by C₁—C₄alkyl; C₇—C₂₅phenylalkyl which is interrupted by oxygen, sulfur or

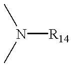

and which is unsubstituted or substituted on the phenyl radical 1 to 3 times by C₁—C₄alkyl, or else the radicals R₂₀ and R_{21 ,} together with the carbon atoms to which they are attached, form an unsubstituted or mono- to tri—C₁—C₄alkyl-substituted C₅—C₁₂cycloalkylene ring; R₂₂ is hydrogen or C₁—C₄alkyl, R₂₃ is hydrogen, C₁—C₂₅alkanoyl, C₃—C₂₅alkenoyl, C₃—C₂₅alkanoyl interrupted by oxygen, sulfur or

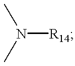

C₂—C₂₅alkanoyl substituted by a di(C₁—C6akyl)phosphonategroup; C₆—C₉cycloalkylcarbonyl, thenoyl, furoyl, benzoyl or C₁—C₁₂alkyl-substituted benzoyl;

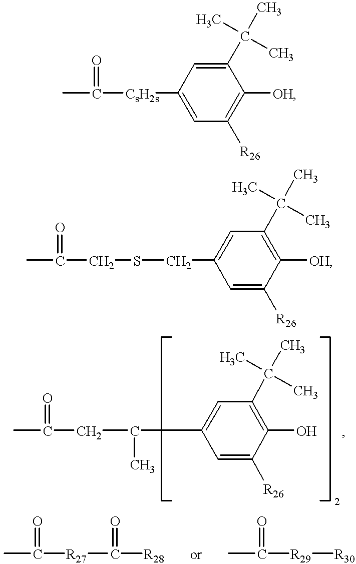

R₂₄ and R₂₅ independently of one another are hydrogen or C₁—C₁₈alkyl, R₂₆ is hydrogen or C₁—C₈alkyl, R₂₇ is a direct bond, C₁—C₁₈alkylene, C₂—C₁₈alkylene interrupted by oxygen, sulfur or

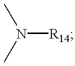

C₂—C₁₈alkenylene, C₂—C₂₀alkylidene, C7—C20phenylalkylidene, C₅—C₈—cycloalkylene, C₇—C₈bicycloalkylene, unsubstituted or C₁—C₄alkyl-substituted phenylene,

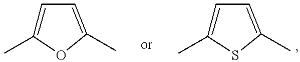

R₂₈ is hydroxyl,

$$[ {—O}^{-} \frac{1}{r} {M}^{r +} ] ,$$

C₁—C₁₈alkoxy or

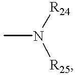

R₂₉ is oxygen, —NH— or

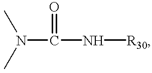

R₃₀ is C₁—C₁₈ alkyl or phenyl, R₃₁ is hydrogen or C₁—C,₈alkyl, M is an r-valent metal cation, X is a direct bond, oxygen, sulfur or —NR₃₁—, n is 1 or 2, p is 0, 1 or 2, q is 1, 2, 3, 4, 5 or 6, r is 1, 2 or 3, and s is 0, 1 or 2.

Unsubstituted or C₁—C₄alkyl-, C₁—C₄alkoxy-, C₁—C₄alkylthio-, hydroxyl-, halogen-, amino-, C₁—C₄alkylamino-, phenylamino- or di(C₁—C₄alkyl)amino-substituted naphthyl, phenanthryl, anthryl, 5,6,7,8-tetrahydro-2-naphthyl, 5,6,7,8-tetrahydro-1-naphthyl, thienyl, benzo[b]thienyl, naphtho[2,3-b]thienyl, thiathrenyl, dibenzofuryl, chromenyl, xanthenyl, phenoxathiinyl, pyrrolyl, imidazolyl, pyrazolyl, pyrazinyl, pyrimidinyl, pyridazinyl, indolizinyl, isoindolyl, indolyl, indazolyl, purinyl, quinolizinyl, isoquinolyl, quinolyl, phthalazinyl, naphthyridinyl, quinoxalinyl, quinazolinyl, cinnolinyl, pteridinyl, carbazolyl, β-carbolinyl, phenanthridinyl, acridinyl, perimidinyl, phenanthrolinyl, phenazinyl, isothiazolyl, phenothiazinyl, isoxazolyl, furazanyl, biphenyl, terphenyl, fluorenyl or phenoxazinyl is, for example, 1-naphthyl, 2-naphthyl, 1-phenylamino-4-naphthyl, 1-methylnaphthyl, 2-methylnaphthyl, 1-methoxy-2-naphthyl, 2-methoxy-1-naphthyl, 1-dimethylamino-2-naphthyl, 1,2-dimethyl-4-naphthyl, 1,2-dimethyl-6-naphthyl, 1,2-dimethyl-7-naphthyl, 1,3-dimethyl-6-naphthyl, 1,4-dimethyl-6-naphthyl, 1,5-dimethyl-2-naphthyl, 1,6-dimethyl-2-naphthyl, 1-hydroxy-2-naphthyl, 2-hydroxy-1-naphthyl, 1,4-dihydroxy-2-naphthyl, 7-phenanthryl, 1-anthryl, 2-anthryl, 9-anthryl, 3-benzo[b]thienyl, 5-benzo[b]thienyl, 2-benzo[b]thienyl, 4-dibenzofuryl, 4,7-dibenzofuryl, 4-methyl-7-dibenzofuryl, 2-xanthenyl, 8-methyl-2-xanthenyl, 3-xanthenyl, 2-phenoxathiinyl, 2,7-phenoxathiinyl, 2-pyrrolyl, 3-pyrrolyl, 5-methyl-3-pyrrolyl, 2-imidazolyl, 4-imidazolyl, 5-imidazolyl, 2-methyl-4-imidazolyl, 2-ethyl-4-imidazolyl, 2-ethyl-5-imidazolyl, 3-pyrazolyl, 1-methyl-3-pyrazolyl, 1-propyl-4-pyrazolyl, 2-pyrazinyl, 5,6-dimethyl-2-pyrazinyl, 2-indolizinyl, 2-methyl-3-isoindolyl, 2-methyl-1-isoindolyl, 1-methyl-2-indolyl, 1-methyl-3-indolyl, 1,5-dimethyl-2-indolyl, 1-methyl-3-indazolyl, 2,7-dimethyl-8-purinyl, 2-methoxy-7-methyl-8-purinyl, 2-quinolizinyl, 3-isoquinolyl, 6-isoquinolyl, 7-isoquinolyl, isoquinolyl, 3-methoxy-6-isoquinolyl, 2-quinolyi, 6-quinolyl, 7-quinolyl, 2-methoxy-3-quinolyl, 2-methoxy-6-quinolyl, 6-phthalazinyl, 7-phthalazinyl, 1-methoxy-6-phthalazinyl, 1,4-dimethoxy-6-phthalazinyl, 1,8-naphthyridin-2-yl, 2-quinoxalinyl, 6-quinoxalinyl, 2,3-di-methyl-6-quinoxalinyl, 2,3-dimethoxy-6-quinoxalinyl, 2-quinazolinyl, 7-quinazolinyl, 2-di-methylamino-6-quinazolinyl, 3-cinnolinyl, 6-cinnolinyl, 7-cinnolinyl, 3-methoxy-7-cinnolinyl, 2-pteridinyl 6-pteridinyl, 7-pteridinyl, 6,7-dimethoxy-2-pteridinyl, 2-carbazolyl, 3-carbazolyl, 9-methyl-2-carbazolyl, 9-methyl-3-carbazolyl, p-carbolin-3-yl, 1-methyl-,-carbolin-3-yl, 1-methyl-β-carbolin-6-yl, 3-phenanthridinyl, 2-acridinyl, 3-acridinyl, 2-perimidinyl, 1-methyl-5-perimidinyl, 5-phenanthrolinyl, 6-phenanthrolinyl, 1-phenazinyl, 2-phenazinyl, 3-isothiazolyl, 4-isothiazolyl, 5-isothiazolyl, 2-phenothiazinyl, 3-phenothiazinyl, 10-methyl-3-phenothiazinyl, 3-isoxazolyl, 4-isoxazolyl, 5-isoxazolyl, 4-methyl-3-furazanyl, 2-phenoxazinyl or 10-methyl-2-phenoxazinyl.

Particular preference is given to unsubstituted or C₁—C₄alkyl-, C₁—C₄alkoxy-, C₁—C₄alkylthio-, hydroxyl-, phenylamino- or di(C₁—C₄alkyl)amino-substituted naphthyl, phenanthryl, anthryl, 5,6,7,8-tetrahydro-2-naphthyl, 5,6,7,8-tetrahydro-1-naphthyl, thienyl, benzo[b]thienyl, naphtho[2,3-b] thienyl, thiathrenyl, dibenzofuryl, chromenyl, xanthenyl, phenoxathiinyl, pyrrolyl, isoindolyl, indolyl, phenothiazinyl, biphenyl, terphenyl, fluorenyl or phenoxazinyl such as, for example, 1-naphthyl, 2-naphthyl, 1-phenylamino-4-naphthyl, 1-methylnaphthyl, 2-methyl-naphthyl, 1-methoxy-2-naphthyl, 2-methoxy-1-naphthyl, 1-dimethylamino-2-naphthyl, 1,2-dimethyl-4-naphthyl, 1,2-dimethyl-6-naphthyl, 1,2-dimethyl-7-naphthyl, 1,3-dimethyl-6-naphthyl, 1,4-dimethyl-6-naphthyl, 1,5-dimethyl-2-naphthyl, 1,6-dimethyl-2-naphthyl, 1 -hydroxy-2-naphthyl, 2-hydroxy-1-naphthyl, 1,4-dihydroxy-2-naphthyl, 7-phenanthryl, 1-anthryl, 2-anthryl, 9-anthryl, 3-benzo[b]thienyl, 5-benzo[b]thienyl, 2-benzo[b]thienyl, 4-dibenzofuryl, 4,7-diben-zofuryl, 4-methyl-7-dibenzofuryl, 2-xanthenyl, 8-methyl-2-xanthenyl, 3-xanthenyl, 2-pyrrolyl, 3-pyrrolyl, 2-phenothiazinyl, 3-phenothiazinyl, 10-methyl-3-phenothiazinyl.

Halogen is for example chlorine, bromine or iodine. Chlorine is preferred.

Alkanoyl of up to 25 carbon atoms is a branched or unbranched radical such as formyl, acetyl, propionyl, butanoyl, pentanoyl, hexanoyl, heptanoyl, octanoyl, nonanoyl, decanoyl, undecanoyl, dodecanoyl, tridecanoyl, tetradecanoyl, pentadecanoyl, hexadecanoyl, heptadecanoyl, octadecanoyl, eicosanoyl or docosanoyl, for example. Preference is given to alkanoyl of 2 to 18, especially 2 to 12, e.g. 2 to 6 carbon atoms. Acetyl is particularly preferred.

C₂—C₂₅Alkanoyl substituted by a di(C₁—C₆alkyl)phosphonate group is for example (CH₃CH₂O)₂POCH₂CO—, (CH₃O)₂POCH₂CO—, (CH₃CH₂CH₂CH₂O)₂POCH₂CO—, (CH₃CH₂O)₂POCH₂CH₂CO—, (CH₃O)₂POCH₂CH₂CO—, (CH₃CH₂CH₂CH₂O)₂POCH₂CH₂CO—, (CH₃CH₂O)₂PO(CH₂)₄CO—, (CH₃CH₂O)₂PO(CH₂)₈CO— or (CH₃CH₂O)₂PO(CH₂)₁₇CO—.

Alkanoyloxy of up to 25 carbon atoms is a branched or unbranched radical such as formyloxy, acetoxy, propionyloxy, butanoyloxy, pentanoyloxy, hexanoyloxy, heptanoyloxy, octanoyloxy, nonanoyloxy, decanoyloxy, undecanoyloxy, dodecanoyloxy, tridecanoyloxy, tetradecanoyloxy, pentadecanoyloxy, hexadecanoyloxy, heptadecanoyloxy, octadecanoyloxy, eicosanoyloxy or docosanoyloxy, for example. Preference is given to alkanoyloxy of 2 to 18, especially 2 to 12, e.g. 2 to 6 carbon atoms. Acetoxy is particularly preferred.

Alkenoyl of 3 to 25 carbon atoms is a branched or unbranched radical such as propenoyl, 2-butenoyl, 3-butenoyl, isobutenoyl, n-2,4-pentadienoyl, 3-methyl-2-butenoyl, n-2-octenoyl, n-2-dodecenoyl, isododecenoyl, oleoyl, n-2-octadecenoyl or n-4-octadecenoyl, for example. Preference is given to alkenoyl of 3 to 18, especially 3 to 12, e.g. 3 to 6, in particular 3 to 4 carbon atoms.

C₃—C₂₅Alkenoyl interrupted by oxygen, sulfur or

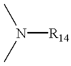

is for example CH₃OCH₂CH₂CH═CHCO— or CH₃OCH₂CH₂OCH═CHCO—.

Alkenoyloxy of 3 to 25 carbon atoms is a branched or unbranched radical such as propenoyloxy, 2-butenoyloxy, 3-butenoyloxy, isobutenoyloxy, n-2,4-pentadienoyloxy, 3-methyl-2-butenoyloxy, n-2-octenoyloxy, n-2-dodecenoyloxy, isododecenoyloxy, oleoyloxy, n-2-octadecenoyloxy or n-4-octadecenoyloxy, for example. Preference is given to alkenoyloxy of 3 to 18, especially 3 to 12, e.g. 3 to 6, in particular 3 to 4 carbon atoms.

C₃—C₂₅Aikenoyloxy interrupted by oxygen, sulfur or

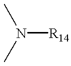

is for example CH₃0CH₂CH₂CH═CHCOO— or CH₃0CH₂CH₂0CH═CHCOO—.

C₃—C₂₅AIkanoyl interrupted by oxygen, sulfur or

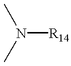

is for example CH₃—O—CH₂CO—, CH₃—S—CH₂CO—, CH₃—NH—CH₂CO—, CH₃—N(CH₃)—CH₂CO—, CH₃—O—CH₂CH₂—O—CH₂CO—, CH₃—(O—CH₂CH₂—)₂O—CH₂CO—, CH₃—(O—CH₂CH₂—)₃O—CH₂CO— or CH₃—(O—CH₂CH₂—)₄O—CH₂CO—. C₃—C₂₅Alkanoyloxy interrupted by oxygen, sulfur or

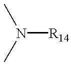

is for example CH₃—O—CH₂COO—, CH₃—S—CH₂COO—, CH₃—NH—CH₂COO—, CH₃—N(CH₃)—CH₂CO—, CH₃—O—CH₂CH₂—O—CH₂COO—, CH₃—(O—CH₂CH₂—)₂O—CH₂COO—, CH₃—(O—CH₂CH₂—)₃—CH₂COO— or CH₃—(O—CH₂CH₂—)₄O—CH₂COO—.

C₆—C₉Cycloalkylcarbonyl is for example cyclohexylcarbonyl, cycloheptylcarbonyl or cyclooctylcarbonyl. Cyclohexylcarbonyl is preferred.

C₆—C₉Cycloalkylcarbonyloxy is for example cyclohexylcarbonyloxy, cycloheptylcarbonyloxy or cyclooctylcarbonyloxy. Cyclohexylcarbonyloxy is preferred.

C₁—C₁₂Alkyl-substituted benzoyl, which preferably carries 1 to 3, especially 1 or 2 alkyl groups, is for example o-, m- or p-methylbenzoyl, 2,3-dimethylbenzoyl, 2,4-dimethylbenzoyl, 2,5-dimethylbenzoyl, 2,6-dimethylbenzoyl, 3,4-dimethylbenzoyl, 3,5-dimethylbenzoyl, 2-methyl-6-ethylbenzoyl, 4-tert-butylbenzoyl, 2-ethylbenzoyl, 2,4,6-trimethylbenzoyl, 2,6-dimethyl-4-tert-butylbenzoyl or 3,5-di-tert-butylbenzoyl. Preferred substituents are Cl-C₈-alkyl, especially C₁-C₄alkyl.

C₁—C₁₂Alkyl-substituted benzoyloxy, which preferably carries 1 to 3, especially 1 or 2 alkyl groups, is for example o-, m- or p-methylbenzoyloxy, 2,3-dimethylbenzoyloxy, 2,4-dimethyl-benzoyloxy, 2,5-dimethylbenzoyloxy, 2,6-dimethylbenzoyloxy, 3,4-dimethylbenzoyloxy, 3,5-dimethylbenzoyloxy, 2-methyl-6-ethylbenzoyloxy, 4-tert-butylbenzoyloxy, 2-ethylbenzoyloxy, 2,4,6-trimethylbenzoyloxy, 2,6-dimethyl-4-tert-butylbenzoyloxy or 3,5-di-tert-butylbenzoyloxy. Preferred substituents are C₁—C₈alkyl, especially C₁—C₄alkyl.

Alkyl of up to 25 carbon atoms is a branched or unbranched radical such as methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetra-methylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl, eicosyl or docosyl, for example. One of the preferred definitions of R₂ and R₄ is, for example, C₁—C₁₈-alkyl. A particularly preferred definition of R₄ is C₁—C₄alkyl.

Alkenyl of 3 to 25 carbon atoms is a branched or unbranched radical such as propenyl, 2-butenyl, 3-butenyl, isobutenyl, n-2,4-pentadienyl, 3-methyl-2-butenyl, n-2-octenyl, n-2-dodecenyl, isododecenyl, oleyl, n-2-octadecenyl or n-4-octadecenyl, for example. Preference is given to alkenyl of 3 to 18, especially 3 to 12, e.g. 3 to 6, in particular 3 to 4 carbon atoms.

Alkenyloxy of 3 to 25 carbon atoms is a branched or unbranched radical such as propenyloxy, 2-butenyloxy, 3-butenyloxy, isobutenyloxy, n-2,4-pentadienyloxy, 3-methyl-2-butenyloxy, n-2-octenyloxy, n-2-dodecenyloxy, isododecenyloxy, oleyloxy, n-2-octadecenyloxy or n-4-octadecenyloxy, for example. Preference is given to alkenyloxy of 3 to 18, especially 3 to 12, e.g. 3 to 6, in particular 3 to 4 carbon atoms.

Alkynyl of 3 to 25 carbon atoms is a branched or unbranched radical such as propynyl (—CH₂—C≡CH), 2-butynyl, 3-butynyl, n-2-octynyl or n-2-dodecynyl, for example. Preference is given to alkynyl of 3 to 18, especially 3 to 12, e.g. 3 to 6, in particular 3 to 4 carbon atoms.

Alkynyloxy of 3 to 25 carbon atoms is a branched or unbranched radical such as propynyloxy (—OCH₂—C≡CH) 2-butynyloxy, 3-butynyloxy, n-2-octynyloxy or n-2-dodecynyloxy, for example. Preference is given to alkynyloxy of 3 to 18, especially 3 to 12, e.g. 3 to 6, in particular 3 to 4 carbon atoms.

C₂—C₂₅Alkyl interrupted by oxygen, sulfur or

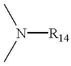

is for example CH₃—O—CH₂—, CH₃—S—CH₂—, CH₃—NH—CH₂—, CH₃—N(CH₃)—CH₂—, CH₃—O—CH₂CH₂—O—CH₂—, CH₃—(O—CH₂CH₂—)₂O—CH₂—, CH₃—(O—CH₂CH₂—)₃0—CH₂— or CH₃—(O—OH₂CH₂—)₄—CH₂—.

C₇—C₉Phenylalkyl is for example benzyl, α-methylbenzyl, α, α-dimethylbenzyl or 2-phenylethyl. Preference is given to benzyl and α, α-dimethylbenzyl.

C₇—C₉Phenylalkyl which is unsubstituted or substituted on the phenyl radical 1 to 3 times by C₁—C₄alkyl is for example benzyl, α-methylbenzyl, α, α-dimethylbenzyl, 2-phenylethyl, 2-methylbenzyl, 3-methylbenzyl, 4-methylbenzyl, 2,4-dimethylbenzyl, 2,6-dimethylbenzyl or 4-tert-butylbenzyl. Benzyl is preferred.

C₇—C₂₅Phenylalkyl which is interrupted by oxygen, sulfur or

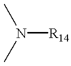

and which is unsubstituted or substituted on the phenyl radical 1 to 3 times by C₁—C₄alkyl is a branched or unbranched radical such as phenoxymethyl, 2-methylphenoxymethyl, 3-methyl-phenoxymethyl, 4-methylphenoxymethyl, 2,4-dimethylphenoxymethyl, 2,3-dimethyl-phenoxymethyl, phenylthiomethyl, N-methyl-N-phenylmethyl, N-ethyl-N-phenylmethyl, 4-tert-butylphenoxymethyl, 4-tert-butylphenoxyethoxymethyl, 2,4-di-tert-butylphenoxymethyl, 2,4-di-tert-butylphenoxy-ethoxymethyl, phenoxyethoxyethoxyethoxymethyl, benzyloxymethyl, benzyloxyethoxymethyl, N-benzyl-N-ethylmethyl or N-benzyl-N-isopropylmethyl, for example.

C₇—C₉Phenylalkoxy is for example benzyloxy, -methylbenzyloxy, α, α-dimethylbenzyloxy or 2-phenylethoxy. Benzyloxy is preferred.

C₁—C₄Alkyl-substituted phenyl, which preferably contains 1 to 3, especially 1 or 2 alkyl groups, is for example o-, m- or p-methylphenyl, 2,3-dimethylphenyl, 2,4-dimethylphenyl, 2,5-dimethylphenyl, 2,6-dimethylphenyl, 3,4-dimethylphenyl, 3,5-dimethylphenyl, 2-methyl-6-ethylphenyl, 4-tert-butylphenyl, 2-ethylphenyl or 2,6-diethylphenyl. C₁—C₄Alkyl-substituted phenoxy, which preferably contains 1 to 3, especially 1 or 2 alkyl groups, is for example o-, m- or p-methylphenoxy, 2,3-dimethylphenoxy, 2,4-dimethylphenoxy, 2,5-dimethylphenoxy, 2,6-dimethylphenoxy, 3,4-dimethylphenoxy, 3,5-dimethylphenoxy, 2-methyl-6-ethylphenoxy, 4-tert-butylphenoxy, 2-ethylphenoxy or 2,6-diethylphenoxy.

Unsubstituted or C₁—C₄alkyl-substituted C₅—C₈cycloalkyl is for example cyclopentyl, methylcyclopentyl, dimethylcyclopentyl, cyclohexyl, methylcyclohexyl, dimethylcyclohexyl, trimethylcyclohexyl, tert-butylcyclohexyl, cycloheptyl or cyclooctyl. Preference is given to cyclohexyl and tert-butylcyclohexyl.

Unsubstituted or C₁—C₄alkyl-substituted C₅—C₈cycloalkoxy is for example cyclopentoxy, methylcyclopentoxy, dimethylcyclopentoxy, cyclohexoxy, methylcyclohexoxy, dimethylcyclohexoxy, trimethylcyclohexoxy, tert-butylcyclohexoxy, cycloheptoxy or cyclooctoxy. Preference is given to cyclohexoxy and tert-butylcyclohexoxy.

Alkoxy of up to 25 carbon atoms is a branched or unbranched radical such as methoxy, ethoxy, propoxy, isopropoxy, n-butoxy, isobutoxy, pentoxy, isopentoxy, hexoxy, heptoxy, octoxy, decyloxy, tetradecyloxy, hexadecyloxy or octadecyloxy, for example. Preference is given to alkoxy of 1 to 12, especially 1 to 8, e.g. 1 to 6 carbon atoms.

C₂—C₂₅Alkoxy interrupted by oxygen, sulfur or

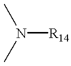

is for example CH₃—O—CH₂CH₂O—, CH₃—S—CH₂CH₂O—, CH₃—NH—CH₂CH₂O—, CH₃—N(CH₃)—CH₂CH₂O—, CH₃O—CH₂CH₂—O—CH₂CH₂O—, CH₃—(O—CH₂CH₂—)₂O—CH₂CH₂O—, CH₃—(O—CH₂CH₂—)₃O—CH₂CH₂O— or CH₃—(O—CH₂CH₂—)₄O—CH₂CH₂O—.

Alkylthio of up to 25 carbon atoms is a branched or unbranched radical such as methylthio, ethylthio, propylthio, isopropylthio, n-butylthio, isobutylthio, pentylthio, isopentylthio, hexylthio, heptylthio, octylthio, decylthio, tetradecylthio, hexadecylthio or octadecylthio, for example. Preference is given to alkylthio of 1 to 12, especially 1 to 8, e.g. 1 to 6 carbon atoms.

Alkylamino of up to 4 carbon atoms is a branched or unbranched radical such as methylamino, ethylamino, propylamino, isopropylamino, n-butylaminro, isobutylamino or tert-butylamino, for example.

Di(C₁—C₄alkyl)amino also means that the two radicals independently of one another are branched or unbranched, such as dimethylamino, methylethylamino, diethylamino, methyl-n-propylamino, methylisopropylamino, methyl-n-butylamino, methylisobutylamino, ethylisopropylamino, ethyl-n-butylamino, ethylisobutylamino, ethyl-tert-butylamino, diethylamino, diisopropylamino, isopropyl-n-butylamino, isopropylisobutylamino, di-n-butylamino or diisobutylamino, for example.

Alkanoylamino of up to 25 carbon atoms is a branched or unbranched radical such as formylamino, acetylamino, propionylamino, butanoylamino, pentanoylamino, Hexanoylamino, heptanoylamino, octanoylamino, nonanoylamino, decanoylamino, undecanoylamino, dodecanoylamino, tridecanoylamino, tetradecanoylamino, pentadecanoylamino, hexadecanoylamino, heptadecanoylamino, octadecanoylamino, eicosanoylamino or docosanoylamino, for example. Preference is given to alkanoylamino of 2 to 18, especially 2 to 12, e.g. 2 to 6 carbon atoms.

C₁—C₁₈Alkylene is a branched or unbranched radical such as methylene, ethylene, propylene, trimethylene, tetramethylene, pentamethylene, hexamethylene, heptamethylene, octamethylene, decamethylene, dodecamethylene or octadecamethylene, for example. Preference is given to C₁—C₁₂alkylene, especially C₁—C₈alkylene.

C₁—C₄Alkyl-substituted C₅—C₁₂cycloalkylene ring, which preferably contains 1 to 3, especially 1 or 2 branched or unbranched alkyl groups, is for example cyclopentylene, methylcyclopentylene, dimethylcyclopentylene, cyclohexylene, methylcyclohexylene, dimethylcyclohexylene, trimethylcyclohexylene, tert-butylcyclohexylene, cycloheptylene, cyclooctylene or cyclodecylene. Preference is given to cyclohexylene and tert-butylcyclohexylene.

C₂—C₁₈Alkylene interrupted by oxygen, sulfur or

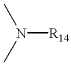

is for example —CH₂—O—CH₂—, —CH₂—S—CH₂—, —CH₂—NH—CH₂—, —CH₂—N(CH₃)—CH₂—, —CH₂—O—CH₂CH₂—O—CH₂—, —CH₂—(O—CH₂CH₂—)₂O—CH₂—, —CH₂—(O—CH₂CH₂—)₃O—CH₂—, —CH₂—(O—CH₂CH₂—)₄0—CH₂— or —CH₂CH₂—S—CH₂CH₂—.

C₂—C₁₈Alkenylene is for example vinylene, methylvinylene, octenylethylene or dodecenylethylene. C₂—C₈Alkenylene is preferred.

Alkylidene of 2 to 20 carbon atoms is for example ethylidene, propylidene, butylidene, pentylidene, 4-methylpentylidene, heptylidene, nonylidene, tridecylidene, nonadecylidene, 1-methylethylidene, 1 -ethylpropylidene or 1 -ethylpentylidene. C₂—C₈Alkylidene is preferred.

Phenylalkylidene of 7 to 20 carbon atoms is for example benzylidene, 2-phenylethylidene or 1 -phenyl-2-hexylidene. C7—C₉Phenylalkylidene is preferred.

C₅—C₈Cycloalkylene is a saturated hydrocarbon group having two free valencies and at least one ring unit and is for example cyclopentylene, cyclohexylene, cycloheptylene or cyclooctylene. Cyclohexylene is preferred.

C₇—C₈Bicycloalkylene is for example bicycloheptylene or bicyclooctylene.

Unsubstituted or C₁—C₄alkyl-substituted phenylene or naphthylene is for example 1,2-, 1,3-, 1,4-phenylene, 1,2-, 1,3-, 1,4-, 1,6-, 1,7-, 2,6- or 2,7-naphthylene. 1,4-Phenylene is preferred.

C₁—C₄Alkyl-substituted C₅—C₈cycloalkylidene ring, which preferably contains 1 to 3, especially 1 or 2 branched or unbranched alkyl groups, is for example cyclopentylidene, methylcyclopentylidene, dimethylcyclopentylidene, cyclohexylidene, methylcyclohexylidene, dimethylcyclohexylidene, trimethylcyclohexylidene, tert-butylcyclohexylidene, cycloheptylidene or cyclooctylidene. Preference is given to cyclohexylidene and tert-butylcyclohexylidene.

A mono-, di- or trivalent metal cation is preferably an alkali metal, alkaline earth metal or aluminium cation, for example Na⁺, K⁺, Mg⁺⁺, Ca⁺⁺ or Al^{+++l .}

Powder coating compositions which are of interest are those comprising as component (b) at least one compound of the formula I in which, if n is 1, R₁ is unsubstituted phenyl or phenyl which is substituted in para position by C₁—C₁₈alkylthio, di(C₁—C₄alkyl)amino, C₂—C₈alkanoyloxy or —CH₂CH₂OR₂₃; mono- to penta-substituted alkylphenyl with in total, together, not more than 18 carbon atoms in the 1 to 5 alkyl substituents; unsubstituted or C₁—C₄alkyl—, C₁—C₄alkoxy-, C₁—C₄alkylthio-, hydroxyl- or amino-substituted naphthyl, biphenyl, terphenyl, phenanthryl, anthryl, fluorenyl, carbazolyl, thienyl, pyrrolyl, phenothiazinyl or 5,6,7,8-tetrahydronaphthyl, and R₂₃ is C₂—C₁₈alkanoyl.

Preference is given to powder coating compositions comprising as component (b) at least one compound of the formula I in which, if n is 2, R₁ is —R₁₂—X—R₁₃—, R₁₂ and R₁₃ are phenylene, X is oxygen or —NR₃₁—, and R₃₁ is C₁—C₄alkyl.

Preference is also given to powder coating compositions comprising as component (b) at least one compound of the formula I in which, if n is 1, R₁ is unsubstituted or C₁—C₄alkyl-, C₁—C₄alkoxy-, C₁—C₄alkylthio-, hydroxyl-, halogen-, amino-, C₁—C₄alkylamino- or di(C₁—C₄alkyl)amino-substituted naphthyl, phenanthryl, thienyl, dibenzofuryl, carbazolyl, fluorenyl or a radical of the formula II

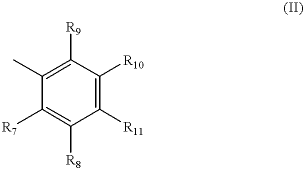

R₇, R₈, Rg, R₁₀ and R₁₁ independently of one another are hydrogen, chlorine, bromine, hydroxyl, C₁—C₁₈alkyl, C₂—C₁₈alkyl interrupted by oxygen or sulfur; C₁—C₁₈alkoxy, C₂—C₁₈-alkoxy interrupted by oxygen or sulfur; C₁—C₁₈alkylthio, C₃—C₁₂alkenyloxy, C₃—C₁₂alkynyloxy, C₇—C₉phenylalkyl, C₇—C₉phenylalkoxy, unsubstituted or C₁—C₄alkyl-substituted phenyl; phenoxy, cyciohexyl, C₅—C₈cycloalkoxy, C₁—C₄alkylamino, di(C₁—C₄alkyl)amino, C₁—C₁₂-alkanoyl, C₃—C₁₂alkanoyl interrupted by oxgyen or sulfur; C₁—C₁₂alkanoyloxy, C₃—C₁₂-alkanoyloxy interrupted by oxygen or sulfur; C₁—C₁₂alkanoylamino, C₃—C₁₂alkenoyl, C₃—C₁₂-alkenoyloxy, cyclohexylcarbonyl, cyclohexylcarbonyloxy, benzoyl or C₁—C₄alkyl-substituted benzoyl; benzoyloxy or C₁—C₄alkyl-substituted benzoyloxy;

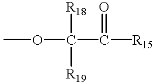

or

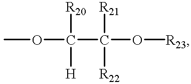

or else in formula 11 the radicals R₇ and R₈ or the radicals R₈ and R₁₁, ,together with the carbon atoms to which they are attached, form a benzo ring, R₁₅ is hydroxyl, C₁—C₁₂alkoxy or

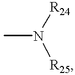

R₁₈ and R₁₉ independently of one another are hydrogen or C₁13 C₄alkyl, R₂₀ is hydrogen, R₂₁ is hydrogen, phenyl, C₁—C₁₈alkyl, C₂—C₁₈alkyl interrupted by oxygen or sulfur; C₇—C₉—phenylalkyl, C₇—C₁₈phenylalkyl which is interrupted by oxygen or sulfur and which is unsubstituted or substituted on the phenyl radical 1 to 3 times by C₁—C₄alkyl, or else the radicals R₂₀ and R₂₁ , together with the carbon atoms to which they are attached, form an unsubstituted or mono- to tri-C₁—C₄alkyl-substituted cyclohexylene ring, R₂₂ is hydrogen or C₁—C₄alkyl, R₂₃ is hydrogen, C₁—C₁₈alkanoyl, C₃—C₁₈alkenoyl, C₃—C₁₂alkanoyl interrupted by oxygen or sulfur; C₂—C₁₂alkanoyl substituted by a di(C₁—C₆alkyl)phosphonate group; C₆—C₉—cycloalkyl-carbonyl, benzoyl,

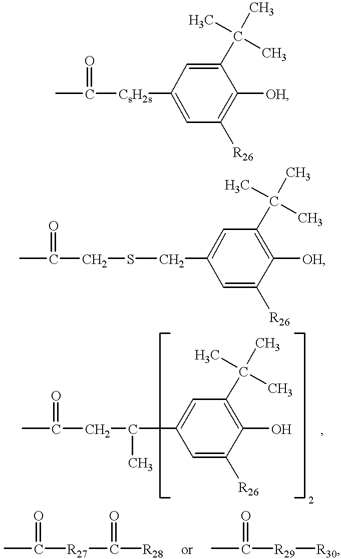

R₂₄ and R₂₅ independently of one another are hydrogen or C₁—C₁₂alkyl, R₂₆ is hydrogen or C₁—C₄alkyl, R₂₇ is C₁—C₁₂alkylene, C₂—C₈alkenylene, C₂—C₈alkylidene, C₇—C₁₂phenylalkylidene, C₅—C₈—cycloalkylene or phenylene, R₂₈ is hydroxyl, C₁—C₁₂alkoxy or

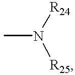

R₂₉ is oxygen or —NH—, R₃₀ is C₁—C₁₈alkyl or phenyl, and s is 1 or 2.

Preference is likewise given to powder coating compositions comprising as component (b) at least one compound of the formula I in which, if n is 1, R₁ is phenanthryl, thienyl, dibenzofuryl, unsubstituted or C₁—C₄alkyl-substituted carbazolyl; or is fluorenyl; or R₁ is a radical of the formula II

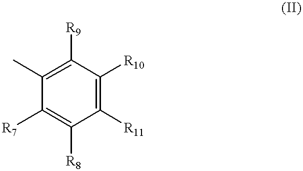

R₇, R₈, R₉, R₁₀ and R₁₁ independently of one another are hydrogen, chlorine, hydroxyl, C₁—C₁₈alkyl, C₁—C₁₈alkoxy, C₁—C₁₈alkylthio, C₃—C₄alkenyloxy, C₃—C₄alkynyloxy, phenyl, benzoyl, benzoyloxy or

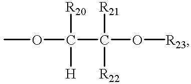

R₂₀ is hydrogen, R₂₁ is hydrogen, phenyl or C₁—C₁₈alkyl, or else the radicals R₂₀ and R₂, together with the carbon atoms to which they are attached, form an unsubstituted or mono- to tri-C₁—C₄alkyl-substituted cyclohexylene ring, R₂₂ is hydrogen or C₁—C₄alkyl, and R₂₃ is hydrogen, C₁—C₁₂alkanoyl or benzoyl.

Particular preference is given to powder coating compositions comprising as component (b) at least one compound of the formula I in which, if n is 1, R₇, R₈, R₉, R₁₀ and R₁₁ independently of one another are hydrogen, C₁—C₁₂alkyl, C₁—C₄—alkyl-thio or phenyl.

Of particular interest are powder coating compositions comprising as component (b) at least one compound of the formula I in which R₂, R₃, R₄ and R₅ independently of one another are hydrogen, chlorine, C₁—C₁₈alkyl, benzyl, phenyl, C₅—C₈cycloalkyl, C₁—C₁₈alkoxy, C₁—C₁₈alkyithio, C₁—C₁₈alkanoyloxy, C₁—C18—alkanoylamino, C₃—C₁₈alkenoyloxy or benzoyloxy; or else the radicals R₂ and R₃ or the radicals R₃ and R₄ or the radicals R₄ and R₅, together with the carbon atoms to which they are attached, form a benzo ring, R₄ is additionally —(CH₂)ₚ—COR,₁₅ or —(CH₂)_{q}OH or, if R₃, R₅ and R₆ are hydrogen, R₄ is additionally a radical of the formula III, R₁₅ is hydroxyl, C₁—C₁₂alkoxy or

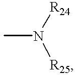

R₁₆ and R₁₇ are methyl groups or, together with the C atom to which they are attached, form an unsubstituted or mono- to tri—C₁—C₄alkyl-substituted C₅—C₈cycloalkylidene ring, R₂₄ and R₂₅ independently of one another are hydrogen or C₁—C₁₂alkyl, p is 1 or 2, and q is 2, 3, 4, 5 or 6.

Also of particular interest are powder coating compositions comprising as component (b) at least one compound of the formula I in which at least two of the radicals R2, R₃, R₄ and R5 are hydrogen.

Of particular interest, especially, are powder coating compositions comprising as component (b) at least one compound of the formula I in which R₃ and R₅ are hydrogen.

Powder coating compositions which are very especially of particular interest are those comprising as component (b) at least one compound of the formula I in which R₂ is C₁—C₄alkyl, R₃ is hydrogen, R₄ is C₁—C₄alkyl or, if R₆ is hydrogen, R₄ is additionally a radical of the formula III, R₅ is hydrogen, and R₁₆ and R₁₇, together with the C atom to which they are attached, form a cyclohexylidene ring.

The following compounds are examples of the type of benzofuran-2-ones which are particularly suitable as component (b) in the powder coating composition of the invention: 3-[4-(2-acetoxyethoxy)phenyl]-5,7-di-tert-butylbenzofuran-2-one; 5,7-di-tert-butyl-3-[4-(2-stearoyl-oxyethoxy)phenyl]benzofuran-2-one; 3,3′-bis[5,7-di-tert-butyl-3-(4-[2-hydroxy-ethoxy]phenyl)-benzofuran-2-one]; 5,7-di-tert-butyl-3-(4-ethoxyphenyl)benzofuran-2-one; 3-(4-acetoxy-3,5-dimethylphenyl)-5,7-di-tert-butylbenzofuran-2-one; 3-(3,5-dimethyl-4-pivaloyloxyphenyl)-5,7-di-tert-butylbenzofuran-2-one; 5,7-di-tert-butyl-3-phenylbenzofuran-2-one; 5,7-di-tert-butyl-3-(3,4-dimethylphenyl)benzofuran-2-one; 5,7-di-tert-butyl-3-(2,3-dimethylphenyl)benzofuran-2-one; 5,7-di-tert-butyl-3-(2,3,4,5,6-pentamethyl)benzofuran-2-one; and the compound of the formula Vc

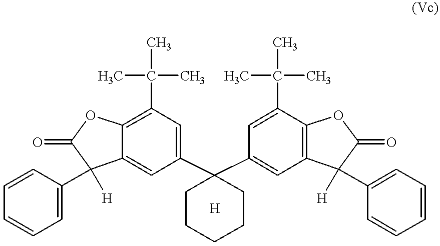

Also of particular interest, especially, are powder coating compositions comprising as component (b) at least one compound of the formula V

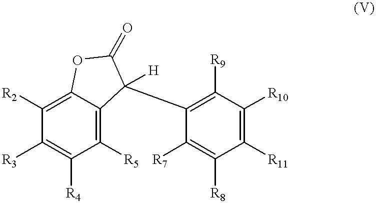

in which R₂ is hydrogen or C₁—C₆alkyl, R₃ is hydrogen, R₄ is hydrogen, C₁—C₆alkyl or a radical of the formula IIIa

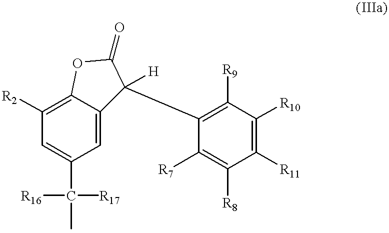

R₅ is hydrogen, R₇, R₈, R₉ and R₁₀ independently of one another are hydrogen, C₁—C₄alkyl or C₁—C₄alkoxy, R₁₁ is hydrogen, C₁—C₄alkyl or C₁—C₄alkoxy, C₂—C₈alkanoyloxy or

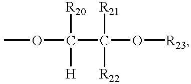

with the proviso that at least two of the radicals R₇, R₈, Rg, R₁₀ and R₁₁ are hydrogen; R₁₆ and R₁₇, together with the C atom to which they are attached, form an unsubstituted or mono- to tri—C₁—C₄alkyl-substituted cyclohexylidene ring, R₂₀, R₂, and R₂₂ are hydrogen, and R₂₃ is C₂—C₁—₈alkanoyl.

Very particular preference is given to powder coating compositions comprising as component (b) at least one compound of the formula V

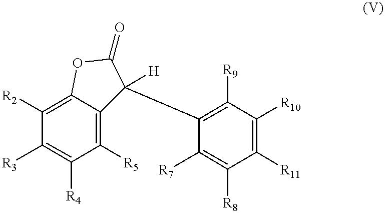

in which R₂ is tert-butyl, R₃ is hydrogen, R₄ is tert-butyl or a radical of the formula IIIa

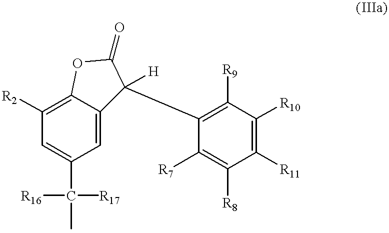

R₅ is hydrogen, R₇, R₈, R₉ and R₁₀ independently of one another are hydrogen, C₁—C₄alkyl or C₁—C₄alkoxy, R₁₁ is hydrogen, C₁—C₄alkyl or C₁—C₄alkoxy, C₂—C₈alkanoyloxy or

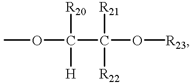

with the proviso that at least two of the radicals R₇, R₈, R₉, R₁₀ and R₁₁ are hydrogen; R₁₆ and R₁₇, together with the C atom to which they are attached, form a cyclohexylidene ring, R₂₀, R₂₁ and R₂₂ are hydrogen, and R₂₃ is C₂—C₁₈alkanoyl.

The compounds of the benzofuran-2-one type as component (b) in the powder coating composition of the invention are known in the literature and their preparation is described, for example, in the following U.S. Pat. Nos. 4,325,863; 4,388,244; 5,175,312; 5,252,643; 5,216,052: 5,369,159; 5,488,117; 5,356,966; 5,367,008; 5,428,162; 5,428,177 or 5,516,920.

Powder coating compositions of interest are those in which the powder coating composition is a composition which is heat-curable, especially in gas ovens.

The term gas ovens refers to ovens which are fed by combustion of hydrocarbons such as methane, propane, butane, coal gas, carbon monoxide, hydrogen or oils, for example. Where the gases are burnt or oxidized with air there is formation, with the nitrogen present in the air, of the nitrogen oxides which are undesirable for the curing of the powder coating composition. The concentration of nitrogen oxides in these gas ovens is from 1 to 500 ppm, in particular from 5 to 100 ppm, e.g. from 10 to 80 ppm.

The present invention therefore also provides powder coating compositions which comprise components (a) and (b) and which in the course of curing are in contact with nitrogen oxides originating from combustion gases.

By “powder coating compositions” or “powder coatings” is meant the definition as described in “Ullmann's Encyclopedia of Industrial Chemistry, 5th, Completely Revised Edition, Vol. A 18”, pages 438 to 444 (1991) in Section 3.4. By powder coatings are meant thermoplastic or bakable, crosslinkable polymers which are applied in powder form to predominantly metallic substrates. The way in which the powder is brought into contact with the workpiece that is to be coated typifies the various application techniques, such as electrostatic powder spraying, electrostatic fluidized-bed sintering, fixed bed sintering, fluidized-bed sintering, rotational sintering or centrifugal sintering.

Preferred organic film-forming binders for the powder coating compositions of the invention are stoving systems based, for example, on epoxy resins, polyester-hydroxyalkylamides, polyester-glycolurils, epoxy-polyester resins, polyester-triglycidyl isocyanurates, hydroxy-functional polyester-blocked polyisocyanates, hydroxy-functional polyester-uretdiones, acrylate resins with hardener, or mixtures of such resins.

Also of interest are film-forming binders having thermoplastic properties, such as polyethylene, polypropylene, polyamides, polyvinyl chloride, polyvinylidene dichloride or polyvinylidene difluoride, for example.

Polyesters are in general hydroxy- or carboxy-functional and are normally prepared by condensation of diols and dicarboxylic acids. By adding polyols and/or polyacids, branched polyesters are obtained which then give rise, in the course of baking in the presence of crosslinkers, to network structures which give the coating the desired physical properties, such as scratch resistance, impact strength and flexural strength. Instead of multifunctional acids it is also possible to use anhydrides or acid chlorides, such as maleic anhydride, itaconic anhydride, phthalic anhydride, terephthalic anhydride, hexahydroterephthalic anhydride, trimellitic anhydride, pyromellitic dianhydride, succinic anhydride, etc. It is also possible to use simple esters such as dimethyl terephthalate for example, in which case the polymerization proceeds by transesterification with elimination of the volatile alcohol. Likewise practicable is a preparation by a combination of transesterification and condensation. Polyesters can be prepared, furthermore, by polycondensation of hydroxycarboxylic acids such as 12-hydroxy-stearic acid and hydroxypivalic acid, or of the corresponding lactones, such as ε-caprolactone, for example. Examples of dicarboxylic acids and polyacids include terephthalic, isophthalic, adipic, azelaic, sebacic, 1,1 2-dodecanedioic, pyromellitic, 3,6-dichlorophthalic, succinic, 1,3-cyclohexanedicarboxylic and 1,4-cyclohexanedicarboxylic acids. Examples of diols and polyols include ethylene glycol, propylene glycol, glycerol, hexanetriol, hexane-2,5-diol, hexane-1,6-diol, pentaerythritol, sorbitol, neopentyl glycol, trimethylolethane, trimethylolpropane, tris-1,4-cyclohexanedimethanol, trimethylpentanediol, 2,2-diethyl-1,3-propane-diol, 2-methyl-2-butyl-1,3-propanediol, esterdiol 204 (ester of hydroxypivalic acid and neopentyl glycol), hydrogenated bisphenol A, bisphenol A, hydroxypivalic acid, hydroxypivalate esters, 2-butyl-2-ethyl-1,3-propanediol, 1,4-butanediol, 2-butene-1,4-diol, 2-butyne-1,4-diol or 2-methyl-1,3-propanediol.

Suitable crosslinking agents for carboxy-functional polyesters are epoxy compounds such as Novolac^{®}-epoxy resins, diglycidyl ethers of bisphenol A, hydrogenated bisphenol A and bisphenol A modified by reaction with, for example, aliphatic dicarboxylic acids. Also suitable are reactive epoxy compounds, such as triglycidyltriazolidine-3,5-dione, the glycidyl esters of polyacids, such as diglycidyl terephthalate and diglycidyl hexahydroterephthalate, hydantoin epoxides (U.S. Pat. No. 4,402,983) and, especially, triglycidyl isocyanurate, epoxidized unsaturated fatty acid esters (for example Uranox^{®} from DSM) and Araldit^{®}PT 910 (Ciba Spezialitätenchemie AG). Further crosslinking agents for carboxy-functional polyesters are β-hydroxyal-kylamides (U.S. Pat. No.4,076,917), such as the predominantly tetrafunctional β-hydroxyalkylamide derivative of adipic acid (Primid^{®} XL552 from Rohm & Haas), for example. Derivatives of melamine, benzoguanimine and glycoluril that have been alkylated with low molecular mass alcohols have also proved suitable. Examples are tetramethylmethoxyglycoluril (Powderlink^{®} 1174 from American Cyanamid). In addition, bis- and trisoxazolidines, such as 1,4-bisoxazo-lidinobenzene, for example, are also known as crosslinking agents.

More recent are carboxy-functional polyesters which contain chemically bonded epoxy groups and are thus able to crosslink with themselves (Molhoek et al., 22nd Fatipec Congress, 15-19.5.95, Budapest, Vol.1, 119-132).

In all systems in which an epoxy group or a glycidyl radical reacts with a carboxyl group or with an anhydride in a crosslinking reaction, it is possible to employ catalysts. Examples are amines or metal compounds such as aluminium acetylacetonate or tin octoate, for example.

The polyisocyanate crosslinkers are of particular importance as crosslinking agents for hydroxy-functional polyesters. In order to prevent premature crosslinking, because of the high reactivity of isocyanates, and to obtain good levelling of the melted powder, the polyisocyanates are blocked (internally in the form of a uretdione, or as an adduct with a blocking agent). Blocking agents most commonly employed are ε-caprolactam, methyl ethyl ketoxime or butanone oxime. Other suitable blocking agents for isocyanates are described in the publications by G. B. Guise, G. N. Freeland and G. C. Smith, J. Applied Polymer Science, 23, 353 (1979) and by M. Bock and H. -U. Maier-Westhues in “Progress in Product Development for Powder Coating Technology, XIX th Int. Conf. on Organic Coatings, Science and Technol., Athens, 12-16 July”, 1993. Examples of blocked and unblocked polyisocyanates include 2-methylpentane 1,5-diisocyanate, 2-ethylbutane 1,4-diisocyanate, 3(4)-isocyanatomethyl-1-methylcyclohexyl isocyanate, 3-isocyanatomethyl-3,5,5-trimethylcyclohexane diisocyanate, tris(isocyanatomethyl)benzene, 4,4′-diisocyanatodicyclohexylmethane, 1,4-bis(isocyanato-methyl) cyclohexane, m-tetramethylxylene diisocyanate, p-tetramethylxylene diisocyanate and, in particular, isophorone diisocyanate. For deblocking it is common to add a metallic catalyst, such as tin octoate, dibutyltin oxide or dibutyltin dilaurate, for example, to the polyisocyanate formulation.

Further suitable crosslinking agents for hydroxy-functional polyesters are anhydrides such as trimellitic anhydride and its reaction products with diols and diamines. Further examples of such crosslinking agents are described by T. A. Misev in “Powder Coatings: Chemistry and Technology”, published by J. Wiley & Sons, Chichester on pages 123 and 124.

Polyacrylates, which commonly possess hydroxyl, carboxyl or glycidyl functionality, are also employed as binders for powder coatings. They are prepared by the customary methods, principally from monomers such as styrene and linear or branched C₁—C₈alkyl esters of acrylic or methacrylic acid. In addition, other ethylenically unsaturated compounds, such as divinylbenzene, acrylamide, methacrylamide, butoxymethylacrylamide, acrylonitrile, butadiene, etc., can be added and copolymerized. Hydroxyl functionality is ensured by the copolymerization of hydroxy-functional monomers such as hydroxyethyl acrylate, hydroxyethyl methacrylate, hydroxypropyl acrylate, hydroxypropyl methacrylate, for example. For carboxyl functionality use is made of ethylenically unsaturated acids and anhydrides, such as acrylic, methacrylic, itaconic and crotonic acid, and maleic, itaconic, acrylic or methacrylic anhydrides (U.S. Pat. No. 3,836,604). Glycidyl functionality is provided, as taught in EP-A-0 256 369 and U.S. Pat. No. 3,876,578, by the copolymerization of monomers such as glycidyl acrylate and glycidyl methacrylate. As crosslinking agents for polyacrylates with hydroxyl or carboxyl functionality it is possible in principle to use the same compounds as already described for the polyesters with hydroxyl or carboxyl functionality. Further suitable crosslinking agents are the epoxy compounds of U.S. Pat. No. 0,045,040. Suitable crosslinking agents for polyacrylates with glycidyl functionality are dicarboxylic acids, such as sebacic acid and 1,12-dodecanedicarboxylic acid, and anhydrides, such as bistrimellitic anhydride, for example, and the compounds described in U.S. Pat. No. 3,880,946. DE-A-3 310 545, furthermore, discloses self-crosslinking polyacrylates.

Epoxy resins for powder coatings are usually either Novolac^{®}-epoxy resins or, in particular, those based on aromatic polyols, especially those based on bisphenols such as bisphenol A. Also known are modified bisphenol epoxy resins, from JP-A-58 187 464 (1982). The epoxy resins are employed in combination with crosslinkers from the classes of the solid aliphatic amines, solid aromatic amines, amine adducts, phenolic resins, polyacids and the already described carboxy-functional polyesters. Hardeners deserving of very special mention are the dicyandiamides, which are frequently employed together with a catalyst, examples of which are Lewis acids, boron trifluoride-amine complexes, metal complexes, tertiary or quaternary amines, and imidazoline derivatives, such as 2-methylimidazoline.

Component (b) is judicially used in an amount of from 0.001 to 10% by weight, for example from 0.01 to 5% by weight, preferably from 0.025 to 3% by weight and, in particular, from 0.05 to 3% by weight, based on the weight of component (a).

In addition to components (a) and (b) the powder coating compositions of the invention may comprise further additives.

Preferred powder coating compositions of the invention comprise, as further additives, one or more components from the group consisting of pigments, dyes, fillers, levelling assistants, devolatilizing agents, charge control agents, optical brighteners, adhesion promoters, antioxidants, light stabilizers, curing catalysts, photoinitiators, wetting auxiliaries or corrosion protection agents.

Corrosion protection agents are, for example, anticorrosion pigments, such as phosphate- or borate-containing pigments or metal oxide pigments, or other organic or inorganic corrosion inhibitors, examples being salts of nitroisophthalic acid, phosphorus esters, technical-grade amines, substituted benzotriazoles or (2-benzothiazolylthio)succinic acid (Irgacor^{®}252, Ciba Spezialitätenchemie AG).

Examples of devolatilizing agents are fatty acid amides as described in EP-A-0 471 409, ε-caprolactam, stearic acid, methyl and dimethyl isophthalate (EP-A-284 996) and, especially, benzoin.

Examples of levelling assistants are epoxidized fatty acids, abietyl alcohol, polylauryl methacrylate, polylauryl acrylate, polydimethylsiloxane-polyalkylene oxide block copolymers or, in particular, low molecular weight polymers and copolymers of C₁—C₈alkyl acrylate esters or alkyl methacrylate esters.

Adhesion promoters are based, for example, on modified silanes, titanates or zirconates.

The pigments are, for example, titanium dioxide, iron oxide, carbon black, aluminium bronze, phthalocyanine blue, aminoanthraquinone, barium sulfate or lithopone.

Examples of suitable wetting auxiliaries are fluorinated wetting agents such as Fluorad^{®} FC 430 (from 3M, USA).

Suitable photoinitiators for UV-curing powder coatings are based on benzophenones, phenylglyoxalates, bis- and also mono-acylphosphine oxides, α-hydroxy ketones or benzil dimethyl ketals. Mixtures of photoinitiators are also suitable.

A particularly suitable optical brightener is Uvitex^{®}OB (Ciba Spezialitätenchemie AG).

Examples of fillers are talc, alumina, aluminium silicate, aluminium phosphate, barite, mica, silica, calcium carbonate or magnesium carbonate, magnesium oxide, zinc oxide, zinc carbonate, zinc phosphate or mixtures thereof.

In addition to component (b) the powder coating compositions of the invention may include further costabilizers (additives), examples of which are the following:

1. Antioxidants

1.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(a-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example, 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof.

1.2. Alkylthiomethvlphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.

1.3. Hydroquinones and alkylated hydroguinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tertbutyl-4-hydroxyanisole, 3,5-di-tert-butyl-4-hydroxyphenyl stearate, bis-(3,5-di-tert-butyl-4-hydroxyphenyl) adipate.

1.4. Tocopherols, for example α-tocopherol, β-tocopherol, γ-tocopherol, δ-tocopherol and mixtures thereof (Vitamin E).

1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis-(3,6-di-sec-amylphenol), 4,4′-bis(2,6-dimethyl-4-hydroxyphenyl) disulfide.

1.6. Alkylidenebisphenols, for example 2,2′-methylenebis(6-tert-butyl-4-methylphenol), 2,2′-methylenebis (6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butyl-phenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis (2,6-di-tert-butylphenol), 4,4′-methylenebis(6-tert-butyl-2-methylphenol), 1,1 -bis(5-tert-butyl-4-hydroxy-2-methylphenyl) butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl) butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1 -bis-(3,5-dimethyl-2-hydroxyphenyl)butane, 2,2-bis-(3,5-di-tert-butyl-4-hydroxyphenyl) propane, 2,2-bis-(5-tert-butyl-4-hydroxy2-methylphenyl)-4-n-dodecylmercaptobutane, 1, 1,5,5-tetra-(5-tert-butyl-4-hydroxy-2-methylphenyl)pentane.

1.7. O—, N— and S—benzyl compounds, for example 3,5,3′, 5′-tetra-tert-butyl-4,4′-dihydroxydibenzyl ether, octadecyl-4-hydroxy-3,5-dimethylbenzylmercaptoacetate, tridecyl-4-hydroxy3,5-di-tert-butylbenzylmercaptoacetate, tris(3,5-di-tert-butyl-4-hydroxybenzyl)amine, bis(4-tert-butyl-3-hydroxy-2,6-dimethylbenzyl) dithioterephthalate, bis(3,5-di-tert-butyl-4-hydroxybenzyl) sulfide, isooctyl-3,5-di-tert-butyl-4-hydroxybenzylmercaptoacetate.

1.8. Hydroxybenzvlated malonates, for example dioctadecyl-2,2-bis-(3,5-di-tert-butyl-2-hydroxybenzyl)-malonate, di-octadecyl-2-(3-tert-butyl-4-hydroxy-5-methylbenzyl)-malonate, didodecylmercaptoethyl-2,2-bis-(3,5-di-tert-butyl-4-hydroxybenzyl) malonate, bis[4-(1,1,3,3-tetramethylbutyl) phenyl]-2,2-bis(3,5-di-tert-butyl-4-hydroxybenzyl)malonate.

1.9. Aromatic hydroxybenzyl compounds, for example 1,3,5-tris-(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

1.10. Triazine Compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris-(3,5-di-tert-butyl-4-hydroxybenzyl) isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl) isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxylauranilide, 4-hydroxystearanilide, octyl N-(3,5-di-tert-butyl-4-hydroxyphenyl)carbamate.

1.13. Esters of β-(3,5-di-tert-butvl-4-hvdroxvphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl) oxamide, 3-thiaundecanol, 3-thiapentadecanol, trimethylhexanediol, trimethylolpropane, 4-hydroxymethyl-1 -phospha-2,6,7-trioxabicyclo[2.2.2]octane.

1.14. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl) oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.15. Esters of β-(3,5-dicvclohexvl-4-hydroxy)phenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1 -phospha-2,6,7-trioxabicyclo [2.2.2]octane.

1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N∝-bis(hydroxyethyl)oxamide, 3-thiaundecanol, 3-thiapentadecanol, trimethylhexanediol, trimethylolpropane, 4-hydroxymethyl-1 -phospha-2,6,7-trioxabicyclo[ 2.2.2]octane.

1.17. Amides of β-(3,5-di-tert-butyl-4-hydroxyphenyl)propionic acid e.g. N,N′-bis(3,5-di-tertbutyl-4-hydroxyphenylpropionyl) hexamethylenediamide, N,N′-bis(3,5-di-tert-butyl-4-hydroxyphenylpropionyl) trimethylenediamide, N,N′-bis(3,5-di-tert-butyl-4-hydroxyphenylpropionyl)-hydrazide, N,N′-bis[2-(3-[3,5-di-tert-butyl-4-hydroxyphenyl]propionyloxy)ethyl]oxamide (Naugard^{®}XL-1 supplied by Uniroyal).

1.18. Ascorbic acid (vitamin C)

1.19. Aminic antioxidants, for example N,N′-di-isopropyl-p-phenylenediamine, N,N′-di-secbutyl-p-phenylenediamine, N,N′-bis(1,4-dimethylpentyl)-p-phenylenediamine, N,N′-bis(1 -ethyl-3-methylpentyl)-p-phenylenediamine, N,N′-bis(1 -methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenlenediamine, 4-(p-toluenesulfamoyl)diphenylamine, N,N′-dimethyl-N,N′-di-sec-butyl-p-phenylenediamine, diphenylamine, N-allyidiphenylamine, 4-isopropoxy-diphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1 ,2-bis[(2-methylphenyl)amino]ethane, 1,2-bis(phenylamino)propane, (o-tolyl)biguanide, bis[4-(1′,3′-dimethylbutyl)phenyl]amine, tertoctylated N-phenyl-1-naphthylamine, a mixture of mono- and dialkylated tert-butyl/tertoctyidiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- und dialkylated tert-butyidiphenylamines, 2,3-dihydro-3,3-dimethyl-4H-1,4-benzothiazine, phenothiazine, a mixture of mono- und dialkylated tert-butyl/tert-octylphenothiazines, a mixture of mono- und dialkylated tert-octyl-phenothiazines, N-allylphenothiazin, N,N,N′,N′-tetraphenyl-1,4-diaminobut-2-ene, N,N-bis-(2,2,6,6-tetramethyl-piperid-4-yl-hexamethylenediamine, bis(2,2,6,6-tetramethylpiperid-4-yl)-sebacate, 2,2,6,6-tetramethylpiperidin-4-one, 2,2,6,6-tetramethylpiperidin-4-ol.

2. UV absorbers and light stabilisers

2.1. 2-(2′-Hydroxyphenvl)benzotriazoles, for example 2-(2′-hydroxy-5′-methylphenyl)-benzotriazole, 2-(3′, 5′-di-tert-butyl-2′-hydroxyphenyl)benzotriazole, 2-(5′-tert-butyl-2′-hydroxyphenyl) benzotriazole, 2-(2′-hydroxy-5′-(1,1,3,3-tetramethylbutyl)phenyl)benzotriazole, 2-(3′, 5′-ditert-butyl-2′-hydroxyphenyl)-5-chloro-benzotriazole, 2-(3′-tert-butyl- 2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl) benzotriazole, 2-(3′, 5′-di-tert-amyl-2′-hydroxyphenyl)benzotriazole, 2-(3′, 5′-bis-(α,α-dimethylbenzyl)-2′-hydroxyphenyl)benzotriazole, 2-(3′-tert-butyl-2′-hydroxy-5′-(2-octyloxycarbonylethyl) phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl) phenyl)-5-chloro-benzotriazole, 2-(3′-tert-butyl-2′-hydroxy-5′-(2-methoxycarbonylethyl) phenyl)benzotriazole, 2-(3′-tert-butyl-2′-hydroxy-5′-(2-octyloxycarbonylethyl) phenyl)benzotriazole, 2-(3′-tert-butyl-5′-[2-(2-ethylhexyloxy)carbonylethyl]-2′-hydroxyphenyl) benzotriazole, 2-(3′-dodecyl-2′-hydroxy-5′-methylphenyl)benzotriazole, 2-(3′-tert-butyl-2′-hydroxy-5′-(2-isooctyloxycarbonylethyl) phenylbenzotriazole, 2,2′-methylene-bis-[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂]_{₂} where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)-phenyl] benzotriazole; 2-[2′-hydroxy-3′-(1,1,3,3-tetramethylbutyl)-5′-(α,α-dimethylbenzyl)-phenyl] benzotriazole.

2.2. 2-Hydroxvbenzophenones, for example the 4-hydroxy, 4-methoxy, 4-octyloxy, 4-decyloxy, 4-dodecyloxy, 4-benzyloxy, 4,2′, 4′-trihydroxy and 2′-hydroxy-4,4′-dimethoxy derivatives.

2.3. Esters of substituted and unsubstituted benzoic acids, as for example 4-tertbutyl-phenyl salicylate, phenyl salicylate, octylphenyl salicylate, dibenzoyl resorcinol, bis(4-tert-butylbenzoyl) resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxy-benzoate, 2-methyl-4,6-di-tert-butylphenyl 3,5-di-tert-butyl-4-hydroxybenzoate.

2.4. Acrylates, for example ethyl β-cyano-β,β-diphenylacrylate, isooctyl α-cyano-β,β-diphenylacrylate, methyl α-carbomethoxycinnamate, methyl α-cyano-β-methyl-p-methoxy-cinnamate, butyl α-cyano-β-methyl-p-methoxy-cinnamate, methyl α-carbomethoxy-p-methoxycinnamate and N-(β-carbomethoxy-β-cyanovinyl)-2-methylindoline.

2.5. Nickel compounds, for example nickel complexes of 2,2′-thio-bis-[4-(1,1,3,3-tetramethylbutyl) phenol], such as the 1:1 or 1:2 complex, with or without additional ligands such as n-butylamine, triethanolamine or N-cyclohexyldiethanolamine, nickel dibutyidithiocarbamate, nickel salts of the monoalkyl esters, e.g. the methyl or ethyl ester, of 4-hydroxy-3,5-di-tertbutylbenzylphosphonic acid, nickel complexes of ketoximes, e.g. of 2-hydroxy-4-methylphenyl undecylketoxime, nickel complexes of 1-phenyl-4-lauroyl-5-hydroxypyrazole, with or without additional ligands.

2.6. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1 -octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butane-tetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tertbutylbenzyl) malonate, 3-n-octyl-7,7,9,9-tetramethyl-1,3,8-triazaspiro[4.5]decan-2,4-dione, bis(1 -octyloxy-2,2,6,6-tetramethylpiperidyl)sebacate, bis(1 -octyloxy-2,2,6,6-tetramethylpiperidyl) succinate, linear or cyclic condensates of N,N′-bis-(2,2,6,6-tetramethyl-4-piperidyl) hexamethylenediamine and 4-morpholino-2,6-dichloro-1,3,5-triazine, the condensate of 2-chloro-4,6-bis(4-n-butylamino-2,2,6,6-tetramethylpiperidyl )-1,3,5-triazine and 1,2-bis(3-aminopropylamino) ethane, the condensate of 2-chloro-4,6-di-(4-n-butylamino-1,2,2,6,6-pentamethylpiperidyl)-1,3,5-triazine and 1,2-bis-(3-aminopropylamino)ethane, 8-acetyl-3-dodecyl-7,7,9,9-tetramethyl-1 ,3,8-triazaspiro[4.5] decane-2,4-dione, 3-dodecyl- 1 -(2,2,6,6-tetramethyl-4-piperidyl) pyrrolidin-2,5-dione, 3-dodecyl-1 -(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensation product of N,N′-bis(2,2,6,6-tetramethyl-4-piperidyl)hexamethylenediamine and 4-cyclohexylamino-2,6-dichloro-1,3,5-triazine, a condensation product of 1,2-bis(3-aminopropylamino) ethane and 2,4,6-trichloro-1,3,5-triazine as well as 4-butylamino-2,2,6,6-tetramethylpiperidine (CAS Reg. No. [136504-96-6]); N-(2,2,6,6-tetramethyl-4-piperidyl)-n-dodecylsuccinimid, N-(1,2,2,6,6-pentamethyl-4-piperidyl)-n-dodecylsuccinimid, 2-undecyl-7,7,9,9-tetramethyl-1-oxa-3,8-diaza-4-oxo-spiro[4,5] decane, a reaction product of 7,7,9,9-tetramethyl-2-cycloundecyl-1-oxa-3,8-diaza-4-oxospiro [4,5] decane und epichlorohydrin, 1,1-bis(1,2,2,6,6-pentamethyl-4-piperidyloxycarbonyl)-2-(4-methoxyphenyl) ethene, N,N′-bisformyl-N,N′-bis(2,2,6,6-tetramethyl-4-piperidyl) hexamethylenediamine, diester of 4-methoxy-methylene-malonic acid with 1,2,2,6,6-pentamethyl-4-hydroxypiperidine, poly[methylpropyl-3-oxy-4-(2,2,6,6-tetramethyl-4-piperidyl)] siloxane, reaction product of maleic acid anhydride-α-olefin-copolymer with 2,2,6,6-tetramethyl-4-aminopiperidine or 1,2,2,6,6-pentamethyl-4-aminopiperidine.

2.7. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.8. 2-(2-Hydroxvphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis (2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis-(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxy-propoxy)phenyl]-4,6-bis(2,4-dimethyl)-1,3,5-triazine, 2-[2-hydroxy-4-(2-hydroxy-3-octyloxy-propyloxy)phenyl]-4,6-bis(2,4-dimethyl)-1,3,5-triazine, 2-[4-(dodecyloxy/tridecyloxy-2-hydroxypropoxy)-2-hydroxy-phenyl]-4,6-bis(2,4-dimethylphenyl)-1,3,5-triazine, 2-[2-hydroxy-4-(2-hydroxy-3-dodecyloxy-propoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxy-propoxy) phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1 -oxy)-2-hydroxypropyloxy]phenyl}-4,6-bis (2,4-dimethylphenyl)-1 ,3,5-triazine.

3. Metal deactivators, for example N,N′-diphenyloxamide, N-salicylal-N′-salicyloyl hydrazine, N,N′-bis(salicyloyl) hydrazine, N,N′-bis(3,5-di-tert-butyl-4-hydroxyphenylpropionyl) hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyl-oyl) oxalyl dihydrazide, N,N′-bis(salicyloyl)thiopropionyl dihydrazide.

4. Phosphites and phosphonites, for example triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di-tert-butylphenyl) phosphite, diisodecyl pentaerythritol diphosphite, bis(2,4-di-tert-butylphenyl) pentaerythritol diphosphite, bis(2,6-ditert-butyl-4-methylphenyl)-pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl) pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz-[d,g]-1 ,3,2-dioxaphosphocin, 6-fluoro-2,4,8, 1 0-tetra-tert-butyl-1 2-methyl-dibenz[d,g]-1 ,3,2-dioxaphosphocin, bis(2,4-di-tert-butyl-6-methylphenyl) methyl phosphite, bis(2,4-di-tert-butyl-6-methylphenyl) ethyl phosphite, 2,2′, 2′-nitrilo[triethyltris(3,3′, 5,5′-tetra-tert-butyl-1,1′-biphenyl-2,2′-diyl) phosphite], 2-ethylhexyl(3,3′, 5,5′-tetra-tert-butyl-1,1′-biphenyl-2,2′-diyl)phosphite.

Especially preferred are the following phosphites:

Tris(2,4-di-tert-butylphenyl) phosphite (Irgafos^{®}168, Ciba-Geigy), tris(nonylphenyl) phosphite,

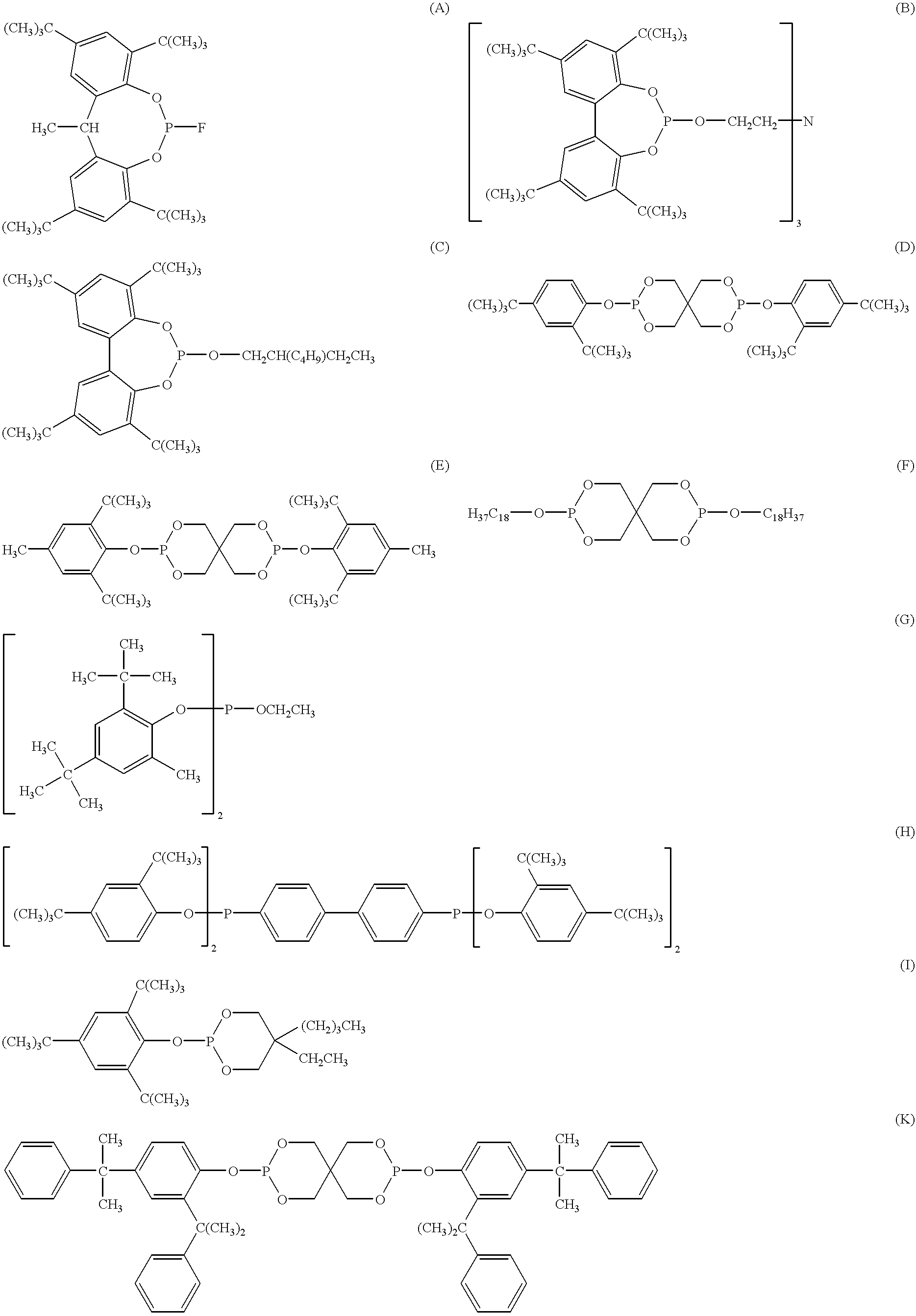

Especially preferred are tris(2,4-di-tert-butylphenyl) phosphite [lrgafos^{®}′168, Ciba Spezialitä tenchemie AG], bis(2,4-di-tert-butyl-6-methylphenyl) ethyl phosphite [lrgafos^{®}′38, Ciba Spezialitä tenchemie AG, formula (G)], Ultranox^{®}626 [GE Chemicals, formula (D)], tetrakis(2,4-ditert-butylphenyl)-4,4′-biphenylen diphosphonite [Irgafos^{®}′P-EPQ, Ciba Spezialitätenchemie AG, formula (H)], Ultranox^{®}641 [GE Chemicals, formula (I)], Doverphos^{®}S9228 [Dover Chemicals, formula (K)] or Mark^{®}HP10 [Adeka Argus, formula (L)].

5. Hydroxylamines, for example, N,N-dibenzylhydroxylamine, N,N-diethylhydroxylamine, N, N-dioctylhydroxylamine, N,N-dilaurylhydroxylamine, N, N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.

6. Nitrones, for example, N-benzyl-alpha-phenyl-nitrone, N-ethyl-alpha-methyl-nitrone, N-octyl-alpha-heptyl-nitrone, N-lauryl-alpha-undecyl-nitrone, N-tetradecyl-alpha-tridcyl-nitrone, N-hexadecyl-alpha-pentadecyl-nitrone, N-octadecyl-alpha-heptadecyl-nitrone, N-hexadecyl-alpha-heptadecyl-nitrone, N-ocatadecyl-alpha-pentadecyl-nitrone, N-heptadecyl-alpha-heptadecyl-nitrone, N-octadecyl-alpha-hexadecyl-nitrone, nitrone derived from N,N-dialkylhydroxylamine derived from hydrogenated tallow amine.

7. Thiosynergists, for example, dilauryl thiodipropionate or distearyl thiodipropionate.

8. Peroxide scavengers, for example esters of β-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(β-dodecylmercapto)propionate.

The costabilizers are used, for example, in concentrations of from 0.01 to 10%, preferably from 0.025 to 3% by weight, in particular from 0.05 to 3% by weight, based on the weight of component (a).

Particularly preferred additional additives are phenolic antioxidants (item 1 in the list), sterically hindered amines (item 2.6 in the list), phosphites and phosphonites (item 4 in the list) and/or thiosynergists (item 7 in the list).

The additional additives from the group of the phosphites and phosphonites preferably have a melting point of 40-150° C., especially 60-120° C., e.g. 70-110° C. These preferred melting ranges facilitate mixing with components (a) and (b).

The abovementioned additional additives are known compounds, and many of them are obtainable commercially.

In the preparation of the organic film-forming binder [component (a)] by addition polymerization or polycondensation of monomers, component (b) and the above-listed additional additives can be added to the monomers even prior to polymerization.

The powder coating compositions are applied to the substrate by customary methods, especially by electrostatic powder spraying. The powder sprayed from the spray gun is charged electrostatically at a high-voltage electrode and is drawn onto the workpiece under the effect of the airflow and of the electrostatic force of attraction. The “wraparound” effect of the field lines ensures that even undercuts and reverse sides become coated. The applied particles, which adhere by means of Coulomb forces, are melted together (coalesce) in the gas oven and cured. The preferred baking temperatures are between 130 and 230° C. depending on the reactivity of the film-forming binder (resin/hardener system).

Preferred substrates are metallic substrates, such as iron, steel, copper, zinc, tin, magnesium, silicon, titanium or aluminium, and also their alloys.

A preferred embodiment of the present invention is the use of component (b) as stabilizer to reduce the discoloration of heat-curable powder coating compositions (stoving enamels), especially in gas ovens.

The present invention also provides a process for reducing the discoloration of heat-curable powder coating compositions which comprises incorporating into or applying to these compositions at least one component (b).

The invention likewise provides a process for curing powder coating compositions comprising components (a) and (b), wherein curing is conducted in a gas oven.

The invention also provides, furthermore, the coating films applied and cured by the above processes.

The preparation of a powder coating composition with the components (a) and (b) of the invention can take place by the customary methods. A good description of the procedures and machines is given in T. A. Misev′s book: “Powder Coatings: Chemistry and Technology” , J. Wiley & Sons, Chichester in Chapter 5.

In general, all components of the powder coating composition are weighed out and mixed together in an appropriate mixer. This is done using tumble mixers, conical mixers, double-cone mixers, horizontal mixers, blenders and stirring apparatus such as planetary mixers.

The formulation is first of all processed in a heated extruder, usually in the range from 70 to 135° C., preferably from 80 to 120° C., to give a highly homogeneous, melted composition. Apparatus suitable for this purpose comprises single-screw co-compounds, twin-screw extruders and planetary extruders. Metering is usually effected by means of a screw conveyor, a conveyor belt or a shaker trough. Following extrusion, the hot mass is rolled out and cooled, for example on a cooling belt. When it has solidified, the mass is crushed and then ground. Auxiliaries such as silica gel or aluminas, for example, can be added in small amounts before or after grinding. Suitable grinding units are pin-disc mills, ultracentrifugal mills, jet mills and, especially, classifying mills. The powder is subsequently classified and preferably sieved. After grinding it is possible to add, for example, metal-effect pigments or mica. The particle size after grinding is normally in the range from 1 to 100 μm, with a median value of from 3 to 50 μm.

Other techniques for the preparation of powder coatings (EP-B-368 851 or WO-A-92/00342) have more recently been disclosed which can also be employed for this invention. In these techniques, the premixed formulation or extrudate is fed to a heated rotary tube and is spun out centrifugally on a rotary table. At the edge of the table, small, round virtually monodisperse drops are formed which solidify in cooled air before falling to the bottom.

A new process for preparing powder coating compositions consists in mixing components (a) and (b) in liquid carbon dioxide and then removing the carbon dioxide by spray drying or evaporation (see also U.S. Pat. Np. 4,414,370 or U.S. Pat. No. 4,529,787). The stabilizers [component (b)] of the present invention are also extremely suitable for such processes for preparing powder coating compositions.

If component (b) of the present invention has a low melting point (<50° C) or is liquid at room temperature there may be difficulties in handling, since it is not easy to introduce tacky or liquid products into an extruder. Difficulties may also arise if component (b) is solid and has a high melting point (>120° C.) or has a high melt viscosity at the extrusion temperature. Such components (b) cannot be mixed so easily with component (a). In such cases it has been found useful to use component (b) of the present invention in the form of a masterbatch.

A masterbatch is a concentrate of a component (b) in component (a). Component (b) here can be present in dispersion or, preferably, in solution in component (a). The amount of component (b) which a masterbatch can comprise is determined only by the solubility in component (a) or physical properties of the masterbatch, such as the unwanted tendency towards caking in the course of storage, for example. Preferred masterbatches include component (b) in an amount of from 5 to 90%, in particular from 5 to 60%, e.g. 5 to 40%, based on the weight of component (a).

The masterbatches can be prepared as early as during the preparation of component (a). Thus it is possible, for example, in the case of polyesters which are preferably prepared at temperatures of about 240° C., to add component (b) and any other additives in the course of the polycondensation.

An alternative method for use of component (b) in the powder coating composition of the invention also consists of absorbing component (b) on a porous solid. This method is expedient particularly when component (b) is a (viscous) liquid at room temperature. Particularly suitable porous solids are those which have a high oil absorption value and a small particle size such as aluminium oxide or silica gel, for example.

The powder coatings are applied by the methods customary in practice. Corona guns, and also triboelectric spray guns, for example, can be used. It is also possible to generate a triboelectric charge by contact with magnetic carrier particles, as is described, for example, in WO-A-96/15199. In addition, charged powder coatings can be applied to substrates using powder metering units, as described, for example, in EP-A-0 678 466. All variants of the fluidized-bed sintering technique, furthermore, with and without electrostatic charging, can be deployed. For thermoplastic powder coatings, flame spraying methods can also be used.

U.S. Pat. No. 4,268,542 or WO-A-96/32452, for example, disclose powder coating slurries, in which the powder coating is suspended in water with the aid of appropriate dispersants and wetting agents. Such powder coating slurries are sprayed using conventional wet-paint spray guns. After the water has evaporated, the layers of powder coating applied to the substrate can be baked as for usual powder coatings. The powder coating compositions of the invention are particularly suitable for this technique.

The powder coating composition can be baked in electric ovens or in gas ovens. Baking in gas ovens can also take place, in addition, by means of infrared heating or by means of electric heating elements.

The examples which follow illustrate the invention. Parts and percentages are by weight.

Example 1: Measuring the discoloration of powder coatings based on a carboxy-functional polyester and cured in electric and gas ovens.

To prepare the powder coating composition based on a carboxy-functional polyester, components 1 to 6 (formulation without additives) or components 1 to 7 (formulation containing the stabilizers) are employed in the sequence indicated (cf. Table 1).

TABLE 1

Examples
(amount in grams)

| Components | 1a | 1b to 1i |
|---|---|---|
| 1. Crylcoat ® 360^{a)} | 591 | 591 |
| 2. Araldit ® GT 7004^{b)} | 394 | 394 |
| 3. Octadecyltrimethylammonium bromide^{c)} | 3.6 | 3.6 |
| 4. Resiflow ® PV 88^{d)} | 12 | 12 |
| 5. Benzoin^{e)} | 3 | 3 |
| 6. Titanium dioxide type R-KB-5^{f)} | 500 | 500 |
| 7. Stabilizers (see Table 2) | — | 6 |
| Total: | 1503.6 | 1509.6 |

a) Crylcoat^{®}360 from UCB S.A., Drogenbos, Belgium.

b) Araldit^{®} GT 7004 from Ciba Spezialitätenchemie AG is a bisphenol A diglycidyl ether.

c) Octadecyltrimethylammonium bromide from Fluka AG, Buchs, Switzerland.

d) Resiflow^{®} PV 88 from Worl6e Chemie GmbH, Lauenburg, Germany.

e) Benzoin from Fluka AG.

f) Titanium dioxide type R-KB-5 from Bayer AG, Leverkusen, Germany.

The components weighed out in this way are mixed using a planetary stirrer. The mixture is then extruded on a prism extruder at 300 revolutions/minute and at 100° C and is rolled out. The powder coating composition is coarsely comminuted using a bench cutter and is ground in a Retsch ZM-1 ultracentrifugal mill with a 0.75 mm annular-perforation screen at 15,000 revolutions/minute. Finally, the powder is passed through a 30 μm screen on a centrifugal screening machine.

The finished powder coating composition is sprayed electrostatically to a coat thickness of 70 μm onto aluminium panels using an ESB-Wagner corona cup gun at 60 kV. Some of the coated panels are cured at 180° C. for 90 minutes in an electric oven. The remaining coated panels are cured at 1 80° C. for 45 minutes in a gas oven with an N0₂ content of 20 ppm. The yellowness index (YI) of the samples is determined in accordance with ASTM D 1925-70. Low YI values denote little discoloration, high YI values denote severe discoloration of the samples. The less the discoloration, the more effective the stabilizer. The results are summarized in Tables 2 and 3.

TABLE 2
Curing for 90 minutes in an electric oven at 180° C.

| | | Yellowness index |
|---|---|---|
| | Stabilizers | after 90 minutes |
| Examples | (% rel. to components 1 to 5) | (ASTM D 1925-70) |
| Example 1a | — | 3.1 |
| Example 1b | 0.60% Irganox ® HP-136^{g)} | 2.8 |
| Example 1c | 0.50% Irgafos ® 168^{h)} | 2.8 |
| | 0.10% Irganox ® HP-136^{g)} | |
| Example 1d | 0.15% Irgafos ® 168^{h)} | 2.8 |
| | 0.15% HALS mixtureⁱ⁾ | |
| | 0.30% Irganox ® HP-136^{g)} | |
| Example 1e | 0.15% Irgafos ® 168^{h)} | 2.8 |
| | 0.15% Irganox ® 1010^{j)} | |
| | 0.30% Irganox ® HP-136^{g)} | |

TABLE 3
Curing for 45 minutes in a gas oven at 180° C.

| | | Yellowness index |
|---|---|---|
| | Stabilizers | after 90 minutes |
| Examples | (% rel. to components 1 to 5) | (ASTM D 1925-70) |
| Example 1f | — | 4.0 |
| Example 1g | 0.60% Irganox ® HP-136^{g)} | 3.5 |
| Example 1h | 0.50% Irgafos ® 168^{h)} | 3.4 |
| | 0.10% Irganox ® HP-136^{g)} | |
| Beispiel 1i | 0.15% Irgafos ® 168^{h)} | 3.3 |
| | 0.15% HALS mixtureⁱ⁾ | |
| | 0.30% Irganox ® HP-136^{g)} | |

g) Irganox^{®} HP-136 (Ciba Spezialitätenchemie AG) is a mixture of about 85 parts by weight of a compound of the formula Va and about 15 parts by weight of a compound of the formula Vb.

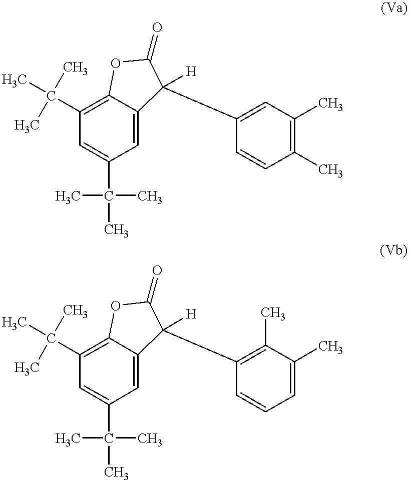

h) Irgafos^{®}168 (Ciba Spezialitätenchemie AG) is tris(2,4-di-tert-butylphenyl) phosphite.

i) HALS mixture is a 1:1 mixture of Tinuvin^{®}622 (Ciba Spezialitätenchemie AG) and Chimassorb^{®}119 (Ciba Spezialitätenchemie AG). Tinuvin^{®}622 (Ciba Spezialitätenchemie AG) is a compound of the formula VI in which the average molecular weight is about 3000.

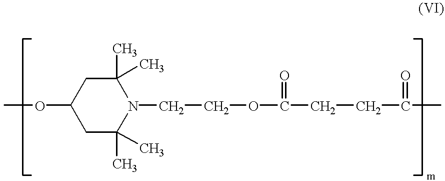

Chimassorb^{®}119 (Ciba Spezialitätenchemie AG) is a condensation product prepared from 2-chloro-4,6-di(4-n-butylamino-1,2,2,6,6-pentamethylpiperidyl)-1,3,5-triazine of the formula VII

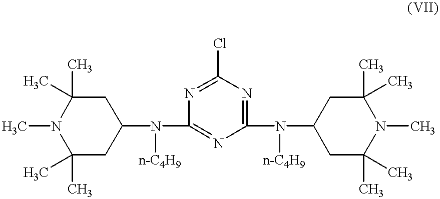

and 1,2-bis(3-aminopropylamino)ethane of the formula VIII

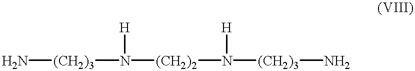

j) Irganox^{®}1010 (Ciba Spezialitatenchemie AG) is the pentaerythritol ester of 3-(3,5-di-tertbutyl-4-hydroxyphenyl) propionic acid (compound of the formula IX)

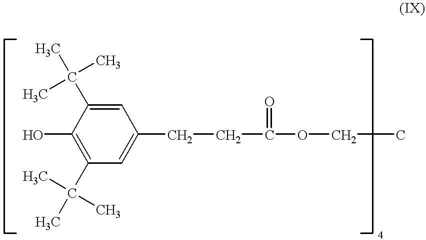

Example 2: Measuring the discoloration of electric-oven cured powder coatings based on a hydroxy-functional polyester-uretdione.

To prepare the powder coating composition based on a hydroxy-functional polyester-uretdione, components 1 to 6 (formulation without additives) and components 1 to 7 (formulation containing stabilizers) are employed in the stated sequence (cf. Table 4).

TABLE 4

Examples (amount in grams)

| Components | 2a | 2b to 2f |
|---|---|---|
| 1. Alftalat ® AN 745^{k)} | 169.2 | 169.2 |
| 2. Vestagon ® BF 1540^{l)} | 27.6 | 27.6 |
| 3. Resiflow ® PV88^{m)} | 2.0 | 2.0 |
| 4. Benzoinⁿ⁾ | 0.8 | 0.8 |
| 5. Metatin catalyst 712ES^{o)} | 0.4 | 0.4 |
| 6. Kronos ® 2160^{p)} | 100.0 | 100.0 |
| 7. Stabilizers (see Table 5) | — | 1.7 |
| Total: | 300.0 | 301.7 |

k) Alftalato^{®} AN 745 is a hydroxy-functional polyester from Vianova Resins SpA, Romano D'Ezzelino, Italy.

I) Vestagon^{®} BF 1540 is a uretdione hardener from Huls AG, Marl, Germany.

m) Resiflow^{®} PV88 is a polyacrylate levelling assistant from Worlee Chemie GmbH, Lauenburg, Germany.

n) Benzoin from Fluka AG.

o) Metatin catalyst 712ES is di-n-butyltin dilaurate from Acimo, Buchs, Switzerland.

p) Kronos^{®}2160 is titanium dioxide from Titan-GmbH, Leverkusen, Germany.

The components weighed out in this way are mixed using a planetary stirrer. The mixture is then extruded on a prism extruder at 300 revolutions/minute and at 130° C. and is rolled out. The powder coating composition is coarsely comminuted using a bench cutter and is ground in a Retsch ZM-1 ultracentrifugal mill with a 0.75 mm annular-perforation screen at 15,000 revolutions/minute. Finally, the powder is passed through a 30 μm screen on a centrifugal screening machine.

The finished powder coating composition is sprayed electrostatically in a layer thickness of 90 μm onto aluminium panels using an ESB-Wagner corona cup gun at 60 kV. The coated panels are cured in an electric oven at 185° C. for 15 minutes. The AE colour of the samples is then determined in accordance with DIN 6174 and 5033, Part 9 against a white standard. Large AE values denote relatively great yellowing. The less the discoloration, the more effective the stabilizer. The results are summarized in Table 5.

TABLE 5
Curing for 15 minutes in an electric oven at 185° C.

| | | ΔE values |
|---|---|---|
| Example | Stabilizer | (DIN 6174 and 5033, Part 9) |
| Example 2a | — | 1.8 |
| Example 2b | (101)^{q)} | 1.6 |
| Example 2c | (102)^{r)} | 1.6 |
| Example 2d | (103)^{s)} | 1.5 |
| Example 2e | (104)^{t)} | 1.6 |
| Example 2f | (105)^{u)} | 1.6 |
| Example 2g | (106)^{v)} | 1.6 |

q) (101) is a compound of the formula Vc.

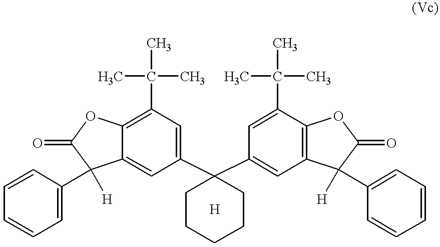

r) (102) is a compound of the formula Vd.

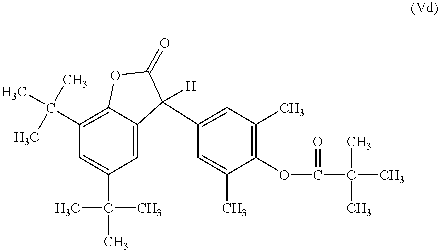

s) (103) is a compound of the formula Ve.

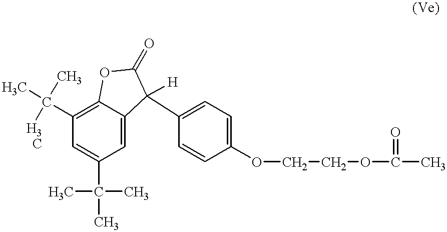

t) (104) is a compound of the formula Vf.

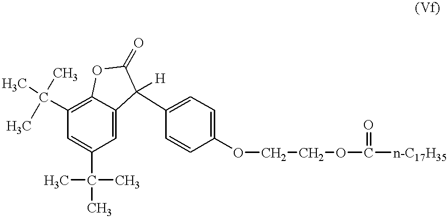

u) (105) is a compound of the formula Vg.

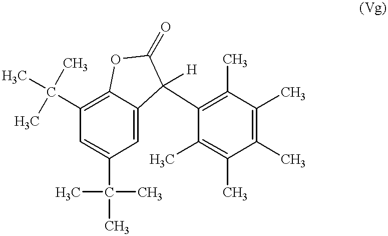

v) (106) is a compound of the formula Vh.

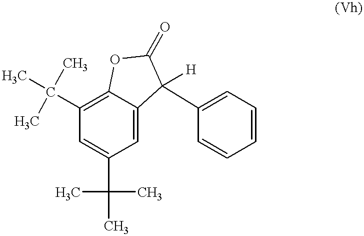

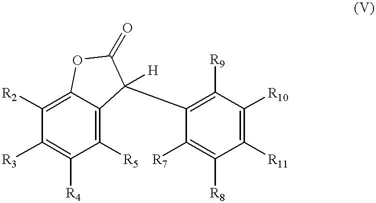

in which R₂ is hydrogen or C₁—C6alkyl, R₃ is hydrogen, R₄ is hydrogen, C₁—C₆alkyl or a radical of the formula IIIa

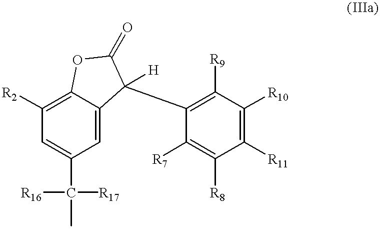

R₅ is hydrogen, R₇, R₈, R₉ and R₁₀ independently of one another are hydrogen, C₁—C₄alkyI or C₁—C₄alkoxy, R₁₁ is hydrogen, C₁—C₄alkyl or C₁—C₄alkoxy, C₂-C₈alkanoyloxy or

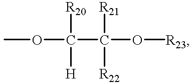

with the proviso that at least two of the radicals R₇, R₈, R₉, R₁₀ and R₁₁ are hydrogen; R₁₆ and R₁₇, together with the C atom to which they are attached, form an unsubstituted or mono- to tri-C₁ -C₄alkyl-substituted cyclohexylidene ring, R₂₀, R₂ and R₂₂ are hydrogen, and R₂₃ is C₂—C₁₈ alkanoyl.

4. A powder coating composition according to claim 1, in which component (b) is a compound of the formula V

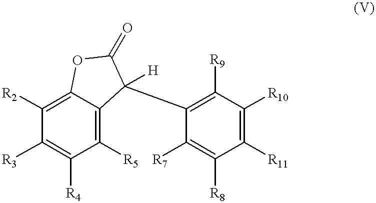

in which R₂ is tert-butyl, R₃ is hydrogen, R₄ tert-butyl or a radical of the formula IIIa

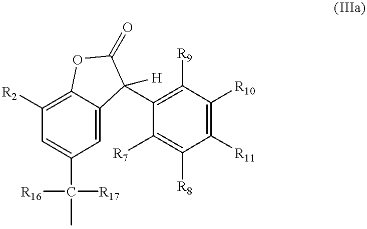

R₅ is hydrogen, R₇, R₈, R₉ and R₁₀ independently of one another are hydrogen, C₁—C₄alkyl or C₁—C₄alkoxy, R₁₁ is hydrogen, C₁—C₄alkyl or C₁—C₄alkoxy, C₂—C₈alkanoyloxy or

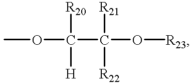

with the proviso that at least two of the radicals R₇, R₈, R₉, R₁₀ and R₁₁ are hydrogen; R₁₆ and R₁₇, together with the C atom to which they are attached, form a cyclohexylidene ring, R₂₀, R₂₁ and R22 are hydrogen, and R₂₃ is C₂—C₁₈alkanoyl.

5. A powder coating composition according to claim 1, in which component (a) is an epoxy resin, a polyester-hydroxyalkylamide, a polyester-glycoluril, an epoxy-polyester resin, a polyester-triglycidyl isocyanurate, a hydroxy-functional polyester-blocked polyisocyanate, a hydroxy-functional polyester-uretdione, an acrylate resin with hardener or a mixture of such resins.

6. A powder coating composition according to claim 1, comprising further additives in addition to components (a) and (b).

7. A powder coating composition according to claim 6, comprising as further additives, in addition, one or more components from the group consisting of pigments, dyes, fillers, levelling assistants, devolatilizing agents, charge control agents, optical brighteners, adhesion promoters, antioxidants, light stabilizers, curing catalysts, photoinitiators, wetting auxiliaries or corrosion protection agents.

8. A powder coating composition according to claim 6, comprising as further additives phenolic antioxidants, sterically hindered amines, organic phosphites or phosphonites; and/or thiosynergists.

9. A powder coating composition according to claim 1, in which component (b) is present in an amount of from 0.001 to 10% based on the weight of component (a).

10. A powder coating composition comprising components (a) and (b) according to claim 1 which in the course of curing is in contact with nitrogen oxides originating from combustion gases.

11. A process for reducing the discoloration of heat-curable powder coating compositions, which comprises incorporating into or applying to these compositions at least one component (b) according to claim 1.

12. A process for curing powder coating compositions comprising components (a) and (b) according to claim 1, wherein curing is conducted in a gas oven.

13. A coating film applied and cured by a process according to claim 11 or 12.

What is claimed is:

1. A powder coating composition comprising
a) an organic film-forming binder and
b) as stabilizer at least one compound of the benzofuran-2-one type.

2. A powder coating composition according to claim 1, in which component (b) is a compound of the formula I 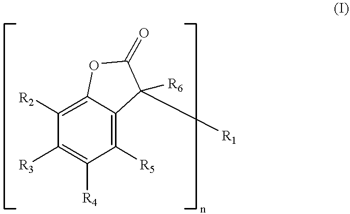
in which, if n is 1,
R₁ is unsubstituted or C₁—C₄alkyl-, C₁—C₄alkoxy-, C₁—C₄alkylthio-, hydroxyl-, halogen-, amino-, C₁—C₄alkylamino-, phenylamino- or di(C₁—C₄alkyl)amino-substituted naphthyl, phenanthryl, anthryl, 5,6,7,8-tetrahydro-2-naphthyl, 5,6,7,8-tetrahydro-1 -naphthyl, thienyl, benzo[b]thienyl, naphtho[2,3-b]thienyl, thianthrenyl, dibenzofuryl, chromenyl, xanthenyl, phenoxathiinyl, pyrrolyl, imidazolyl, pyrazolyl, pyrazinyl, pyrimidinyl, pyridazinyl, indolizinyl, isoindolyl, indolyl, indazolyl, purinyl, quinolizinyl, isoquinolyl, quinolyl, phthalazinyl, naphthyridinyl, quinoxalinyl, quinazolinyl, cinnolinyl, pteridinyl, carbazolyl, β-carbolinyl, phenanthridinyl, acridinyl, perimidinyl, phenanthrolinyl, phenazinyl, isothiazolyl, phenothiazinyl, isoxazolyl, furazanyl, biphenyl, terphenyl, fluorenyl or phenoxazinyl, or R₁ is a radical of the formula II 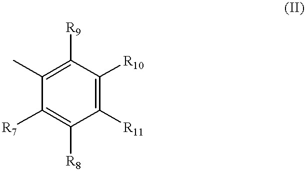
and, if n is 2,
R₁ is unsubstituted or C₁—C₄alkyl- or hydroxyl-substituted phenylene or naphthylene; or is —R₁₂—X—R₁₃—,
R₂, R₃, R₄ and R₅ independently of one another are hydrogen, chlorine, hydroxyl, C₁—C₂₅—alkyl, C₇-C₉phenylalkyl, unsubstituted or C₁—C₄alkyl-substituted phenyl; unsubstituted or C₁—C₄alkyl-substituted C₅—C₈cycloalkyl; C₁—C₁₈alkoxy, C₁—C₁₈alkylthio, C₁—C₄alkylamino, di(C₁—C₄—alkyl)amino, C₁—C₂₅alkanoyloxy, C₁—C₂₅alkanoylamino, C₃—C₂₅alkenoyloxy, C₃—C₂₅—alkanoyloxy interrupted by oxygen, sulfur or 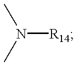
C₆—C₉cycloalkylcarbonyloxy, benzoyloxy or C₁—C₁₂alkyl-substituted benzoyloxy; or else the radicals R₂ and R₃ or the radicals R₃ and R₄ or the radicals R₄ and R₅ , together with the carbon atoms to which they are attached, form a benzo ring, R₄ is additionally —(CH₂)ₚ—COR₁₅ or —(CH₂)_{q}OH or, if R₃, R₅ and R₆ are hydrogen, R₄ is additionally a radical of the formula III 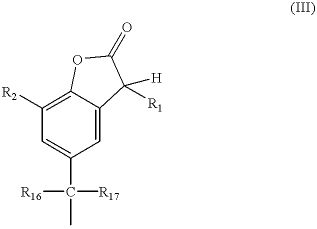
in which R₁ is as defined above for n=1, R₆ is hydrogen or a radical of the formula IV 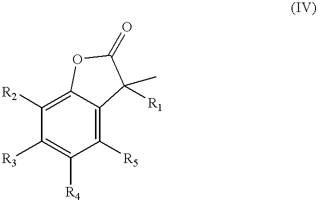
where R₄ is not a radical of the formula III and R₁ is as defined above for n=1, R₇, R₈, R₉, R₁₀ and R₁₁ independently of one another are hydrogen, halogen, hydroxyl, C₁—C₂₅alkyl, C₂—C₂₅alkyl interrupted by oxygen, sulfur or 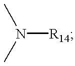
:C₁—C₂₅alkoxy, C₂—C₂₅—alkoxy interrupted by oxygen, sulfur or 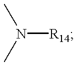
C₁—C₂₅alkylthio, C₃—C₂₅alkenyl, C₃—C₂₅—alkenyloxy, C₃—C₂₅alkynyl, C₃—C₂₅alkynyloxy, C₇'C₉phenylalkyl, C₇—C₉phenylalkoxy, unsubstituted or C₁—C₄alkyl-substituted phenyl; unsubstituted or C₁—C₄alkyl-substituted phenoxy; unsubstituted or C₁—C₄alkyl-substituted C₅—C₈cycloalkyl; unsubstituted or C₁—C₄—alkyl-substituted C₅—C₈cycloalkoxy; C₁—C₄alkylamino, di(C₁—C₄alkyl)amino, C₁—C₂₅alkanoyl, C₃—C₂₅alkanoyl interrupted by oxygen, sulfur or 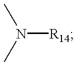
C₁—C₂₅alkanoyloxy, C₃—C₂₅—alkanoyloxy interrupted by oxygen, sulfur or 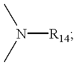
C₁—C₂₅alkanoylamino, C₃—C₂₅—alkenoyl, C₃—C₂₅alkenoyl interrupted by oxygen, sulfur or 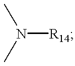
C₃—C₂₅alkenoyloxy, C₃—C₂₅alkenoyloxy interrupted by oxygen, sulfur or 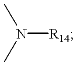
C₆—C₉cycloalkylcarbonyl, C₆—C₉cycloalkylcarbonyloxy, benzoyl or C₁—C₁₂alkyl-substituted benzoyl; benzoyloxy or C₁—C₁₂alkyl-substituted benzoyloxy; 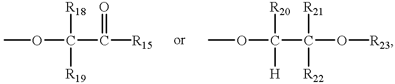
or else, in formula II, the radicals R₇ and R₈ or the radicals R₈ and R₁₁ , together with the carbon atoms to which they are attached, form a benzo ring, R₁₂ and R₁₃ independently of one another are unsubstituted or C₁—C₄alkyl-substituted phenylene or naphthylene, R₁₄ is hydrogen or C₁—C₈alkyl, R₁₅ is hydroxyl,
$$[ {—O}^{-} \frac{1}{r} {M}^{r +} ] ,$$
C₁—C,₈alkoxy or 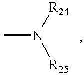
R₁₆ and R₁₇ independently of one another are hydrogen, CF₃, C₁—C₁₂alkyl or phenyl, or R₁₆ and R₁₇, together with the C atom to which they are attached, form an unsubstituted or mono- to tri-C₁—C₄alkyl-substituted C₅—C8cycloalkylidene ring; R₁₈ and R₁₉ independently of one another are hydrogen, C₁—C₄alkyl or phenyl, R₂₀ is hydrogen or C₁—C₄alkyl, R₂₁ is hydrogen, unsubstituted or C₁—C₄alkyl-substituted phenyl; C₁—C₂₅alkyl, C₂—C₂₅alkyl interrupted by oxygen, sulfur or 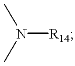
C₇—C₉phenylalkyl which is unsubstituted or substituted on the phenyl radical 1 to 3 times by C₁—C₄alkyl; C₇—C₂₅phenylalkyl which is interrupted by oxygen, sulfur or 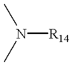
and which is unsubstituted or substituted on the phenyl radical 1 to 3 times by C₁—C₄alkyl, or else the radicals R₂₀ and R₂₁ , together with the carbon atoms to which they are attached, form an unsubstituted or mono- to tri-C₁—C₄alkyl-substituted C₅—C₁₂cycloalkylene ring; R₂₂ is hydrogen or C₁—C₄alkyl, R₂₃ is hydrogen, C₁—C₂₅alkanoyl, C₃—C₂₅alkenoyl, C₃—C₂5alkanoyl interrupted by oxygen, sulfur or 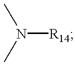
C₂—C₂₅alkanoyl substituted by a di(C₁—C₆alkyl)phosphonate group; C₆—C₉cycloalkylcarbonyl, thenoyl, furoyl, benzoyl or C₁—C₁₂alkyl-substituted benzoyl; 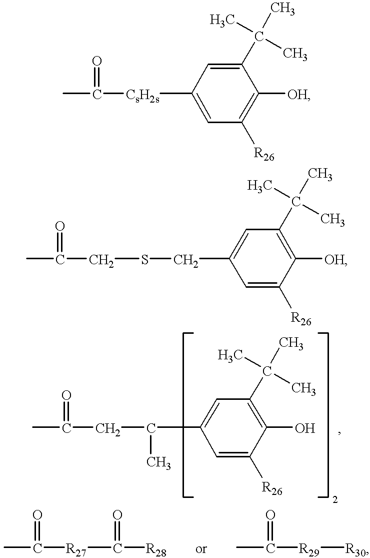
R₂₄ and R₂₅ independently of one another are hydrogen or C₁—C₁₈alkyl, R₂₆ is hydrogen or C₁—C₈alkyl, R₂₇ is a direct bond, C₁—C₁₈alkylene, C₂—C₁₈alkylene interrupted by oxygen, sulfur or 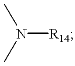
C₂—C₁₈alkenylene, C₂13 C₂₀alkylidene, C₇—C₂₀phenylalkylidene, C₅—C₈—cycloalkylene, C₇—C₈bicycloalkylene, unsubstituted or C₁—C₄alkyl-substituted phenylene, 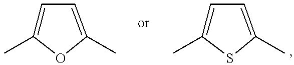
R₂₈ is hydroxyl,
$$[ {—O}^{-} \frac{1}{r} {M}^{r +} ] ,$$
C₁—C₁₈alkoxy or 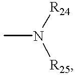
R₂₉ is oxygen, —NH—or 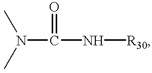
R₃₀ is C₁—C₁₈alkyl or phenyl, R₃₁ is hydrogen or C₁—C₁₈alkyl, M is an r-valent metal cation, X is a direct bond, oxygen, sulfur or —NR₃₁—, n is 1 or 2, pisO, 1 or2, q is 1,2,3,4,5 or6, r is 1, 2 or 3, and sis0, 1 or2.

3. A powder coating composition according to claim 1, in which component (b) is a compound of the formula V
